(19) United States
(12) Patent Application Publication
(10) Pub. No.: US 2026/0116083 A1
(43) Pub. Date: Apr. 30, 2026

(54) RECORDING APPARATUS AND CONTROL METHOD

(71) Applicant: CANON KABUSHIKI KAISHA, Tokyo (JP)

(72) Inventors: SHU KURIHARA, Tokyo (JP); MASAKAZU NAGASHIMA, Kanagawa (JP); YUJIRO ISHIDA, Tokyo (JP); RYOHEI MARUYAMA, Kanagawa (JP); HIROMASA YONEYAMA, Kanagawa (JP); RYUTARO TAKAHASHI, Tokyo (JP); KENTA IIMURA, Tokyo (JP); KEIICHI KITANO, Kanagawa (JP); TAKAYA SATO, Tokyo (JP)

(21) Appl. No.: 19/364,888

(22) Filed: Oct. 21, 2025

(30) Foreign Application Priority Data
Oct. 28, 2024 (JP) 2024-188690

(51) Int. Cl. B41J 2/20; B01F 31/31; B01F 101/35; B41J 2/175; B41J 2/21; C09D 11/037; C09D 11/322; C09D 11/40

(52) U.S. Cl. CPC B41J 2/20; B01F 31/31; B41J 2/17513; B41J 2/17553; B41J 2/17596; B41J 2/2117; C09D 11/037; C09D 11/322; C09D 11/40; B01F 2101/35; B41J 2002/17516

(57) ABSTRACT

A recording apparatus includes a discharge head configured to discharge liquid, a liquid container configured to accommodate the liquid to be supplied to the discharge head, a flow path configured to connect the discharge head and the liquid container, a valve configured to open and close the flow path, and an agitation unit configured to agitate the liquid in the liquid container, wherein, in a case where the agitation unit performs agitation during a recording operation, the valve is closed.

### BACKGROUND

### Field of the Technology

The present disclosure relates to a liquid supply apparatus and a control method.

### Description of the Related Art

Liquids containing substances that sediment can be caused to disperse precipitate upon use. For example, Japanese Patent Laid-Open No. 2018-1443 describes a recording apparatus that records by discharging ink onto recording media, where ink such as pigment ink and metallic ink may be agitated to disperse precipitate upon use.

To reduce sedimentation, agitation can be performed on a regular basis. In some cases, ink may be agitated during discharge. This can affect image quality since the pressure in the liquid container fluctuates due to the agitation.

### SUMMARY

The present disclosure is directed to providing a recording apparatus and a control method capable of performing agitation while reducing adverse effects on image quality.

According to some embodiments of the present disclosure, a recording apparatus includes a discharge head configured to discharge liquid, a liquid container configured to accommodate the liquid to be supplied to the discharge head, a flow path configured to connect the discharge head and the liquid container, a valve configured to open and close the flow path, and an agitation unit configured to agitate the liquid in the liquid container, wherein, in a case where the agitation unit performs agitation during a recording operation, the valve is closed.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a system according to a first embodiment.

FIG. 2 is a front view of the system according to the first embodiment.

FIG. 3 is an explanatory diagram illustrating an internal structure of a recording apparatus.

FIG. 4 is a front view of a storage section.

FIG. 5 is a diagram illustrating the arrangement of containers in liquid storage apparatuses.

FIG. 6 is a rear view of the liquid storage apparatuses.

FIG. 7 is a partially exploded perspective view of the liquid storage apparatuses.

FIG. 8 is a perspective view of a container and a container support unit.

FIGS. 9A and 9B are explanatory diagrams of operation of a handle and a lock mechanism.

FIGS. 10A to 10C are explanatory diagrams of operation of the lock mechanism.

FIG. 11 is a diagram illustrating the mounting orientation and insertion/removal mode of container support units with respect to storage sections.

FIG. 12 is an explanatory diagram of operation of a pressing unit.

FIG. 13 is an explanatory diagram of operation of the pressing unit.

FIGS. 14A and 14B are explanatory diagrams of a cam.

FIG. 15 is a perspective view of a case with agitation function and a container support unit in a separated state.

FIG. 16 is a perspective view of the case with agitation function and the container support unit in a mounted state.

FIGS. 17A to 17C are explanatory diagrams of an agitation operation.

FIG. 18 is a perspective view of the liquid storage apparatuses separated.

FIG. 19 is a perspective view of a liquid agitation device.

FIG. 20 is a perspective view of the liquid agitation device.

FIG. 21 is a front view of accommodation spaces.

FIG. 22 is a diagram illustrating an accommodation mode of container support units.

FIG. 23 is a front view of the liquid agitation device.

FIG. 24 is a perspective view of a rear part of the liquid agitation device.

FIG. 25 is a diagram illustrating an example of an agitation operation.

FIG. 26 is an explanatory diagram of a rotation regulation unit.

FIG. 27 is a diagram illustrating a rotation regulation mode.

FIG. 28 is a diagram illustrating the rotation regulation mode.

FIG. 29 is an explanatory diagram illustrating a position detection operation.

FIG. 30 is an explanatory diagram illustrating a flow path forming member and a valve unit.

FIG. 31 is a diagram illustrating changes in the orientation of the flow path forming member during rotation.

FIG. 32 is an explanatory diagram illustrating the layout of movable-side and stationary-side tube fixing members.

FIG. 33 is an explanatory diagram of a holding member.

FIG. 34 is a diagram illustrating an example of changes in the shape of a tube and the like during rotation.

FIG. 35 is a block diagram of a control circuit of the system illustrated in FIG. 1.

FIG. 36 is an explanatory diagram illustrating a control example.

FIG. 37 is an explanatory diagram illustrating a control example.

FIG. 38 is a diagram illustrating another agitation method.

FIG. 39 is a flowchart for a case where an agitation operation and a recording operation according to the first embodiment are performed.

FIG. 40 is a flowchart for a case where an agitation operation and a recording operation according to a second embodiment are performed.

FIG. 41 is an explanatory diagram illustrating other examples.

FIG. 42 is an explanatory diagram illustrating other examples.

FIG. 43 is an explanatory diagram illustrating another example.

### DESCRIPTION OF THE EMBODIMENTS

Various exemplary embodiments, features, and aspects will be described in detail below with reference to the attached drawings. The following embodiments are not intended to limit the disclosure set forth in the claims. While the embodiments describe a plurality of features, not all of these features are essential to the disclosure, and multiple features may be freely combined. In the attached drawings, the same or similar components are denoted by the same reference numerals, and redundant descriptions will be omitted.

### First Embodiment

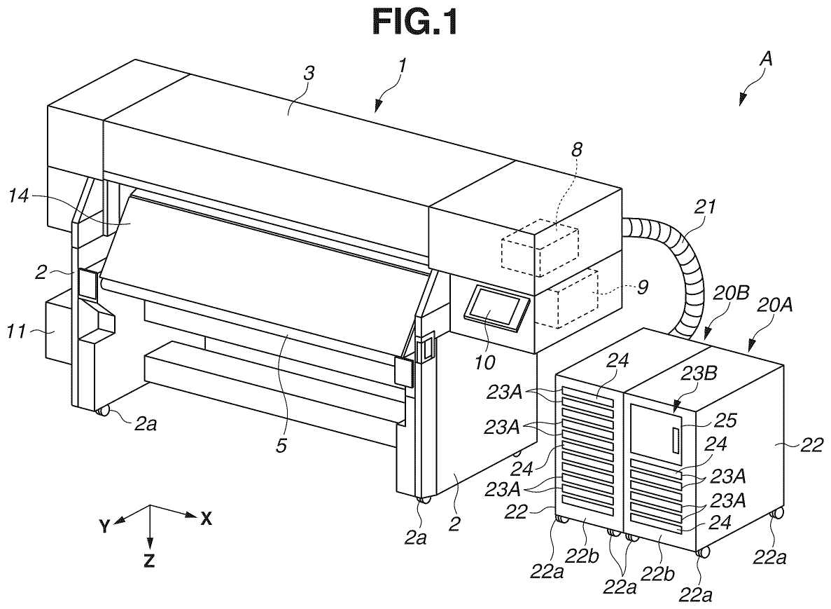

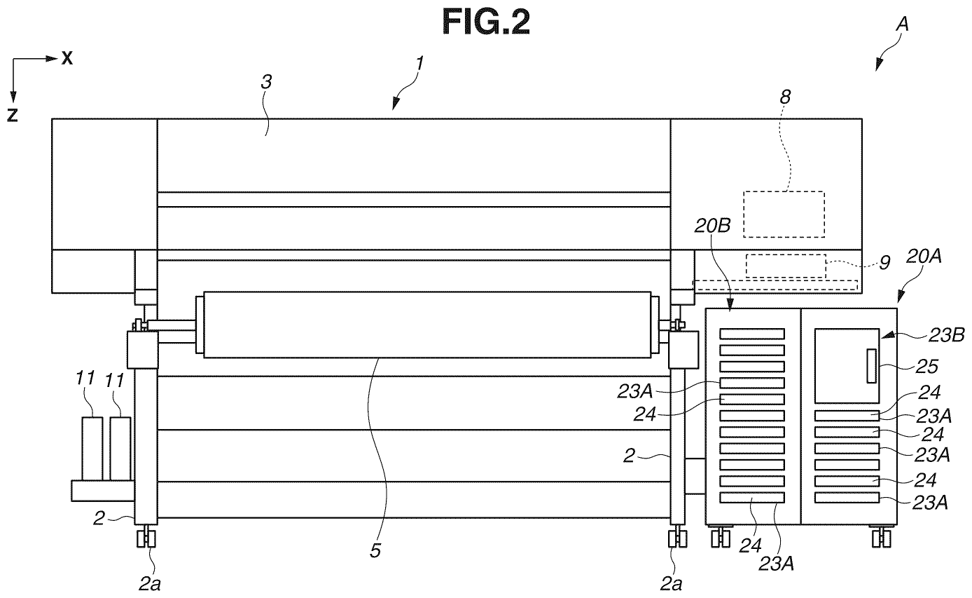

FIG. 1 is a perspective view of a system A according to the present embodiment. FIG. 2 is a front view of the system A. In the drawings, arrows X, Y, and Z indicate mutually intersecting directions, which are orthogonal in the present embodiment. With the system A installed on a horizontal surface, the left-right direction will be referred to as an X direction, the front-rear direction a Y direction, and the up-down direction a Z direction. The X and Y directions may be referred to as lateral directions.

The system A of the present embodiment is a recording system that includes a liquid discharge apparatus 1 and liquid storage apparatuses (liquid supply apparatuses) 20A and 20B, and records images on recording media such as paper by discharging ink. In the present embodiment, two liquid storage apparatuses 20A and 20B are provided. The liquid discharge apparatus 1 and the two liquid storage apparatuses 20A and 20B are arranged in the X direction. The liquid that the liquid storage apparatuses 20A and 20B supply to the liquid discharge apparatus 1 is mainly ink, and the liquid discharge apparatus 1 is a recording apparatus that discharges the ink onto recording media. However, the present disclosure is not limited to a recording system, and can be applied to various liquid discharge systems intended for discharging liquid onto media.

“Recording” covers not only the cases of forming meaningful information such as characters and figures, but also broadly covers the cases of forming images, designs, patterns, and the like on a recording medium or processing a medium, regardless of whether meaningful or meaningless and whether manifested in a manner visually perceptible to humans. In the present embodiment, “recording media” are assumed to be sheets of paper, whereas fabric, plastic films, and the like may be used.

### Liquid Discharge Apparatus

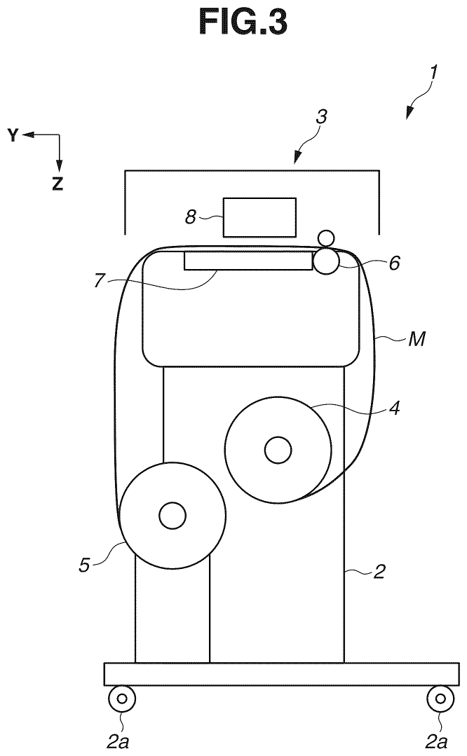

The liquid discharge apparatus 1 will be described with reference to FIG. 3 as well as FIGS. 1 and 2. FIG. 3 is an explanatory diagram illustrating an internal structure of the liquid discharge apparatus 1. The liquid discharge apparatus 1 includes a pair of left and right stands 2 and a main body 3 supported on the pair of stands 2. Each stand 2 is equipped with casters 2a, whereby the liquid discharge apparatus 1 can be moved on the floor (installation surface) relatively easily. A feed unit 4, a drying unit 14, and a take-up unit 5 are located under the main body 3. In the present embodiment, a recording medium M is roll paper, and the feed unit 4 includes a shaft around which the recording medium M is wound. The take-up unit 5 includes a shaft for taking up the recording medium M. While the present embodiment describes roll paper as the recording medium M, cut sheets may also be used.

The main body 3 includes a conveyance unit 6. The conveyance unit 6 includes a driving roller and a driven roller, and the recording medium M fed from the feed unit 4 is nipped in a nip portion between the rollers. Rotation of the driving roller conveys the recording medium M onto a platen 7. A discharge head (recording head) 8 is opposed to the platen 7. The discharge head 8 is a recording head that forms images by discharging ink. The discharge head 8 discharges ink onto the recording medium M conveyed to the platen 7, whereby images are recorded on the recording medium M.

The discharge head 8 includes discharge energy generation elements such as electrothermal transducers (heaters) and piezoelectric elements, and discharges ink from nozzles. In the case of using electrothermal transducers, ink can be caused to bubble by their heat generation, and discharged from the nozzles using the bubbling energy. The discharge head 8 may use a serial scan recording method or a full-line recording method. With the serial scan recording method, the discharge head 8 is mounted on a carriage and reciprocates in the X direction. Discharging ink while moving the discharge head 8 in the X direction will hereinafter be referred to as a recording scan. The conveyance operation of the recording medium M and the recording scan of the discharge head 8 are alternately repeated to record images on the recording medium M. In the present embodiment, the serial scan recording method is assumed to be employed. For the full-line recording method, a long discharge head 8 extending in the X direction is used to record images while continuously conveying the recording medium M.

The image-recorded recording medium M is passed through the drying unit 14 and then taken up on the take-up unit 5. The drying unit 14 reduces liquid components included in the ink applied onto the recording medium M by the discharge head 8 to enhance the fixability between the recording medium M and the ink. The drying unit 14 includes a heat source such as a heater and a blowing mechanism such as a fan, and dries the recording medium M by applying hot air to the passing recording medium M at least at the ink-applied surface side. For improved drying efficiency, the drying unit 14 may be configured to apply hot air not only to the ink-applied surface but to the surface opposite to the ink-applied surface as well. As for the drying method, the drying unit 14 may be configured to combine the application of hot air with a method of irradiating the surface of the recording medium M with electromagnetic waves (such as ultraviolet rays and infrared rays) and/or a conduction heat transfer method through contact with a heating element. Alternatively, the drying unit 14 may simply blow air without a heat source. The image-recorded recording medium M is either cut off by the user with scissors or the like, or automatically cut off by a cutter (not illustrated).

The main body 3 includes a recovery unit 9. The recovery unit 9 is located outside the recording area (outside the discharge area) of the discharge head 8, and preforms processing related to recovery and maintenance of the discharge performance of the discharge head 8. Examples of such processing include preliminary discharge of discharging a predetermined amount of ink before and after a recording operation, and processing for suctioning remaining ink and the like from the nozzles of the discharge head 8. The discharge head 8 is moved to above the recovery unit 9 as illustrated in FIG. 2 when recovery operation is desired.

An operation panel 10 is disposed on the front of the main body 3. The operation panel 10 is a touchscreen, for example, and can accept various setting inputs related to recording and display the statuses of recording jobs etc. The liquid discharge apparatus 1 is also equipped with waste liquid cartridges 11. The waste liquid cartridges 11 are located on the side opposite to the liquid storage apparatuses 20A and 20B in the X direction and under the end portion of the main body 3.

Waste liquid (such as waste ink) suctioned by the recovery unit 9 flows into the waste liquid cartridges 11 for collection. The waste liquid cartridges 11 may be located near the recovery unit 9. In the present embodiment, the waste liquid cartridges 11 are located in the vacant space under the end portion of the main body 3 to reduce the installation footprint of the liquid discharge apparatus 1.

### Liquid Storage Apparatuses

The liquid storage apparatuses 20A and 20B will be described with reference to FIGS. 1 and 2. The liquid storage apparatuses 20A and 20B are apparatuses that store liquid such as ink to be discharged from the discharge head 8 and supply the liquid such as ink to the liquid discharge apparatus 1. The liquid storage apparatuses 20A and 20B include box-shaped main bodies 22 that constitute a plurality of storage sections 23A and a storage section 23B. The main bodies 22 are equipped with casters 22a at the bottom, whereby the liquid storage apparatuses 20A and 20B can be moved on the floor (installation surface) relatively easily.

The liquid storage apparatuses 20A and 20B include a plurality of storage sections 23A arranged in the Z direction.

Each storage section 23A has the form of a slot opened in a front wall portion 22b of the main body 22. A container support unit 24 is detachably inserted into each storage section 23A in the Y direction. The container support unit 24 supports a liquid container 200 (also referred to simply as a container 200) to be described below in a replaceable manner.

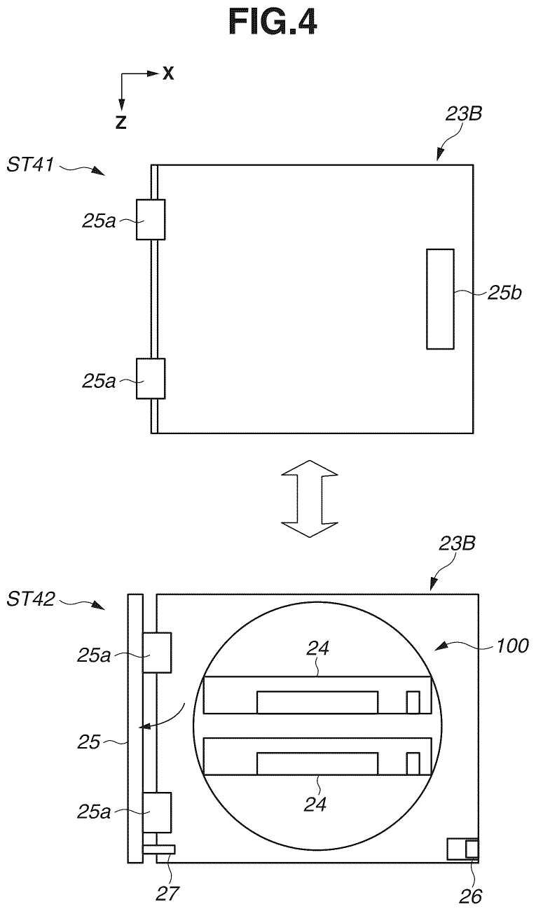

The liquid storage apparatus 20A includes the storage section 23B. The storage section 23B has a larger space than the storage sections 23A opened in the front wall portion 22b of the main body 22, and is opened and closed by an opening-closing member 25 disposed on the front wall portion 22b. FIG. 4 is a front view of the storage section 23B. A state ST41 represents a state where the opening-closing member 25 is closed. A state ST42 represents a state where the opening-closing member 25 is open.

The opening-closing member 25 is a door that is supported at one end portion in the X direction by the front wall portion 22b via a plurality of hinges 25a. A handle 25b that can be gripped by the user is disposed on the other end portion in the X direction. When the user pulls the handle 25b forward from the state ST41, the opening-closing member 25 rotates with the hinges 25a as the rotation center as illustrated in the state ST42, and the interior of the storage section 23B is exposed. While in the present embodiment the opening-closing member 25 has a rotary configuration, the opening-closing member 25 may be a slidable one.

The main body 22 includes a sensor 26 for detecting the opening-closing state of the opening-closing member 25. The sensor 26 detects a detection piece 27 disposed on the opening-closing member 25. For example, if an optical sensor is used as the sensor 26, the optical sensor is located to detect the detection piece 27 when the opening-closing member 25 is closed, and not detect the detection piece 27 when the opening-closing member 25 is open.

A liquid agitation device 100 is built in the storage section 23B. A plurality of container support units 24 is detachably inserted into the liquid agitation device 100 in the Y direction. In the present embodiment, two container support units 24 can be mounted in the liquid agitation device 100. The liquid agitation device 100 has a function of agitating liquid in the containers 200 supported by the container support units 24.

Details of the liquid agitation device 100 will be described below. In the present embodiment, the storage sections 23A and 23B use common container support units 24. However, different container support units may be used.

The storage sections 23A and 23B are equipped with tubes that connect the containers 200 with the liquid discharge apparatus 1. Each tube is connected to the liquid discharge apparatus 1 through a single hose 21 accommodating all the tubes. The ink in the containers 200 is supplied to the discharge head 8 via the tubes.

The system A according to the present embodiment includes the two liquid storage apparatuses 20A and 20B, and can thus use a larger amount of ink. The provision of the multiple liquid storage apparatuses 20A and 20B in this manner is advantageous in increasing the number of ink colors for improved image quality, or increasing the numbers of same-color ink packs for improved productivity.

### Liquid Agitation

The characteristics of liquids accommodated in the liquid storage apparatuses 20A and 20B and agitation performance used for such characteristics will now be described. Pigments with high water resistance and lightfastness, as well as titanium oxide used as white ink pigment, are insoluble and exist in a dispersed state within the ink. When left standing for a long period of time, such components may therefore sediment, accumulate, and aggregate at the bottom of the container 200 due to gravity. To develop desired color, agitation operation may be used to uniformly disperse the foregoing components in the liquid while maintaining a predetermined particle diameter. For that purpose, the liquid and the components may be desirably agitated by generating movements in the liquid that exceed the sedimentation velocity of the particles and that break up particle aggregates.

Ink compositions are known to have various specific gravities with different sedimentation velocities. The higher the sedimentation velocity, the greater the movements may be used for agitation. Too small movements result in insufficient agitation, and too large movements contribute to increased device size. Moreover, multicolor or large-capacity device configurations have made multi-stage configuration of ink containers essential.

In view of this, in the present embodiment, first agitation that is a pressing-based agitation operation with small movements is performed for ink with low sedimentation velocity, and second agitation that is a rotary agitation operation with large movements is performed for ink with high sedimentation velocity.

More specifically, the liquid agitation device 100 built in the storage section 23B is used only for ink with high sedimentation velocity, such as white ink. The orientation of the containers 200 is changed to agitate the ink within the containers 200 (ink within the liquid containers) with large upside-down motions, whereby sedimentation at the bottom of the containers 200 is prevented. By contrast, sedimentation of ink with not so high sedimentation velocity, such as standard color inks, is prevented through motions that do not need large operating space but merely deform the containers 200. The agitation mechanism through the pressing of the containers 200 will be described in detail below.

In the present embodiment, such arrangement of multiple agitation mechanisms enables optimal agitation performance depending on ink characteristics, and also enables multi-stage configuration of ink containers within limited space.

Pigments contained in standard color inks that are used widely, such as cyan, magenta, yellow, and black (hereinafter, C, M, Y, and Bk) inks, have particle diameters of several tens of nanometers and low specific gravities, and can thus be agitated without applying particularly large movements to the containers 200. The foregoing first agitation with small movements is thus performed. On the other hand, titanium oxide used in white ink and the like have large particle diameters and high specific gravities, and thus sediment easily and may use large movements to resolve the sedimentation. The liquid agitation device 100 built in the storage section 23B is thus used for the second agitation with large movements. The liquids to be subjected to the second agitation in the liquid agitation device 100 may be metallic-colored liquids containing metal powder, such as gold and silver liquids. Examples include silver ink containing silver.

Now, the numbers of ink packs (numbers of containers 200) arranged in multiple stages in the liquid storage apparatuses 20A and 20B will be described. For example, even by conservative estimate, a combination of four standard colors, three spot colors, and one white color that is prone to sedimentation may use an eight-stage ink supply system. Moreover, for improved image fixability and water resistance, some printing methods use reaction solutions that promote ink aggregation on the paper surface through chemical reaction. Furthermore, to keep clean the recovery unit 9 that maintains the discharge state of the recording head, cleaning solutions may be prepared and supplied in a manner similar to the inks. Two packs of same-color ink may be provided for the sake of unmanned overnight automatic operation that consumes large amounts of ink, or non-stop printing to prevent ink-out during printing.

In the present embodiment, there are set a total of 19 bag packs (containers 200), including two packs for each of eight colors including standard colors and spot colors, two packs for white in the liquid agitation device 100, and a pack for cleaning solution for cleaning recovery system units. In the case of arranging these packs in the liquid storage apparatuses 20A and 20B in two rows, the six packs for the three standard colors are arranged in one tower (liquid storage apparatus 20A), and the ten packs for the five spot colors are arranged in the other tower (liquid storage apparatus 20B). Compared to a case where the packs for the standard colors and spot colors are arranged together in a row, the numbers of packs in the towers can thereby be better balanced. Moreover, since first agitation control is used for the inks that sediment gently, such as standard color and spot color inks, similarly dividing the numbers of packs for the respective towers enables use of common mechanical components for the first agitation.

The one pack of cleaning solution contains no components prone to sedimentation such as pigments, and does not need agitation control. The one pack that does not need drive transmission for agitation is thus located at the top stage of the liquid storage apparatus 20B. White ink is prone to sedimentation and uses second agitation control, and the liquid agitation device 100 is thus built in the storage section 23B of the liquid storage apparatus 20A.

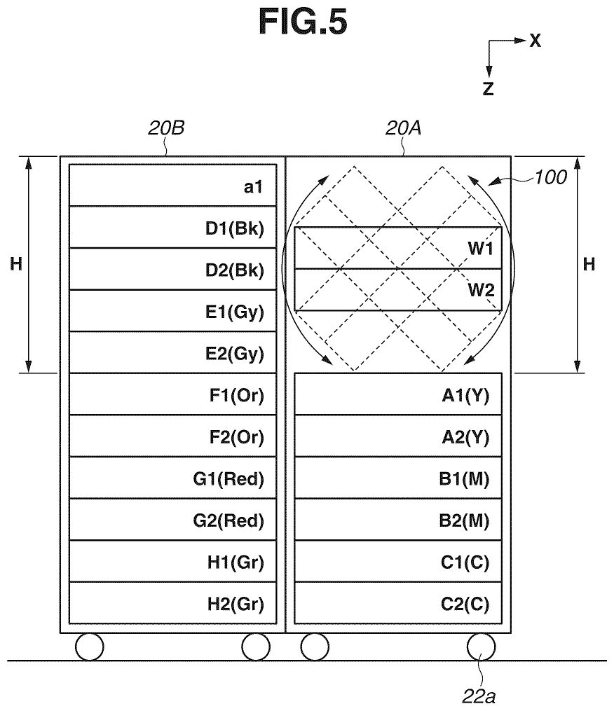

FIG. 5 illustrates the arrangement of the containers 200 described above, where the standard colors and spot colors are denoted by A to H and white by W, with suffixes 1 and 2 indicating two packs of each, and the cleaning solution is denoted by a1. In the present embodiment, the following arrangement is assumed for inks A to H illustrated in FIG. 5.

In the liquid storage apparatus 20A, Y, M, and C inks are arranged in A, B, and C, respectively. In the liquid storage apparatus 20B, Bk, gray (Gy), orange (Or), red (Red), and green (Gr) inks are arranged in D, E, F, G, and H, respectively.

The reason is to agitate inks of similar viscosities using pressing units 600 having the same drive source to be described below, whereby high-viscosity inks can be agitated for a long time and low-viscosity inks for a short time. High-viscosity inks are more difficult to resolve component sedimentation, and may use longer agitation time. Low-viscosity inks are easy to resolve component sedimentation, and the agitation time can be short. This enables optimal agitation operations for the respective inks. In the present embodiment, low-viscosity inks are arranged in the liquid storage apparatus 20B. Inks with higher viscosities are arranged in the liquid storage apparatus 20A. White ink with the highest viscosity is arranged at the top stage of the liquid storage apparatus 20A.

Within the same liquid storage apparatus 20, inks with lower viscosities are placed at lower stages, and inks with higher viscosities at higher stages. High-viscosity inks have high pressure loss, and placing such inks at upper stages where the hydraulic head difference from the discharge head 8 is small can reduce the power used of the ink feed pumps.

The towers (liquid storage apparatuses 20A and 20B) are equipped with casters 22a for floor installation so that the apparatuses can be moved upon delivery or for relocation. The liquid storage apparatuses 20A and 20B are connected and configured for integral movement, but may be configured separately.

With such a configuration, as illustrated in FIG. 5, the liquid storage apparatuses 20A and 20B have the same height if the rotation arc of the liquid agitation device 100 is confined within the same height H as five packs of the containers 200. This is desirable in terms of space efficiency and design.

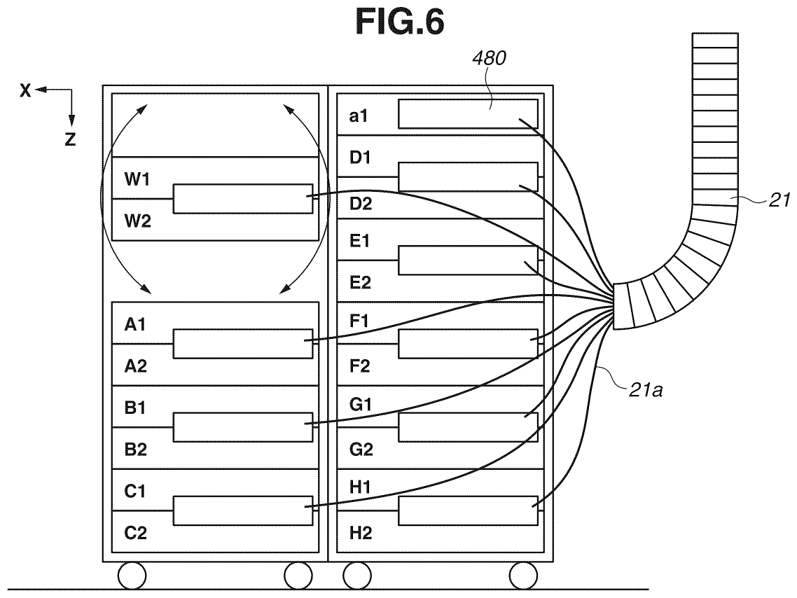

FIG. 6 is a rear view of the liquid storage apparatuses 20A and 20B, with liquid feed units 480 that feed ink from the containers 200. The containers 200 of the same liquid type share a single liquid feed unit 480, and which container 200 to supply ink from is switched using a not-illustrated changeover valve. Since the containers 200 are located below the discharge head 8 and there are hydraulic head differences from the discharge head 8, the liquid feed units 480 have pressure feed capability. The liquid feed units 480 are connected with respective tubes 21a, which are bundled and routed in a flexible hose 21 on the rear side. The discharge head 8 is supplied with the color inks, and the recovery unit 9 with the cleaning solution, through the tubes in the hose 21.

In FIG. 2, the liquid storage apparatuses 20A and 20B of the present embodiment are configured so that their height is lower than the lower surface of the main body 3 projecting to the +X side of the liquid discharge apparatus 1. The liquid storage apparatuses 20A and 20B can thus be housed under the main body 3 as illustrated in FIG. 2. The liquid storage apparatuses 20A and 20B can be brought to the position where the liquid storage apparatuses 20A and 20B contact the stand 2 in the X direction.

The case where the liquid storage apparatuses 20A and 20B are located in the space under the main body 3 will be further described with reference to FIGS. 1, 2, 5, and 6. In FIG. 6, the hose 21 bundling the tubes 21a connected to the liquid storage apparatuses 20A and 20B is connected to the rear side of the liquid discharge apparatus 1. With the casters 22a, the liquid storage apparatuses 20A and 20B can be freely moved and installed close to the liquid discharge apparatus 1.

In FIG. 2, the liquid storage apparatuses 20A and 20B are installed to occupy the space under the main body 3. Since the operation panel 10 is disposed on the main body 3 directly above, the user can replace the containers 200 while viewing information on the operation panel 10, with excellent operability.

The opening-closing member 25 is provided to prevent the white ink containers 200 targeted for second agitation from being operated during rotation for agitation. Unlike the containers 200 of the other colors, the white ink containers 200 may use the operation of opening the opening-closing member 25, and are therefore located at the top stage in view of operability. Inks are more likely to accumulate sediments in the lower part of the tubes by gravity the longer the vertical flow paths extending in the vertical direction. White ink prone to sedimentation is therefore desirably located at the top stage where the vertical flow path from the containers 200 to the main body 3 is the shortest. Moreover, white ink is commonly known to have high viscosity. In consideration of flow path resistance, the white ink containers 200 can therefore be positioned at the top stage where the difference in height (hydraulic head difference) from the discharge head 8 is small. Furthermore, when, for example, white ink is not used, the white ink containers 200 can be simply removed from the top stage to complete the apparatus, which provides high versatility.

The liquid storage apparatuses 20A and 20B are coupled to the liquid discharge apparatus 1 by a coupling member. The reason is to prevent the liquid storage apparatuses 20A and 20B from being inadvertently moved to damage the tubes 21a in the hose 21.

The present embodiment has dealt with the two-tower liquid storage apparatuses 20A and 20B. However, a single-tower liquid storage apparatus including first agitation and second agitation mechanisms may be used. Alternatively, only the second agitation mechanisms may be located under the recovery unit 9, and the first agitation mechanism that does not need large thickness in the height direction may be arranged under the roll paper. The waste liquid cartridges 11 and the liquid storage apparatuses 20A and 20B may be switched in position.

Next, the mechanism for first agitation in the liquid storage apparatuses 20A and 20B will be described. The mechanism for second agitation is implemented by the liquid agitation device 100, and its configuration will be described in detail below.

### Mechanism for First Agitation

### Liquid Containers and Container Support Units

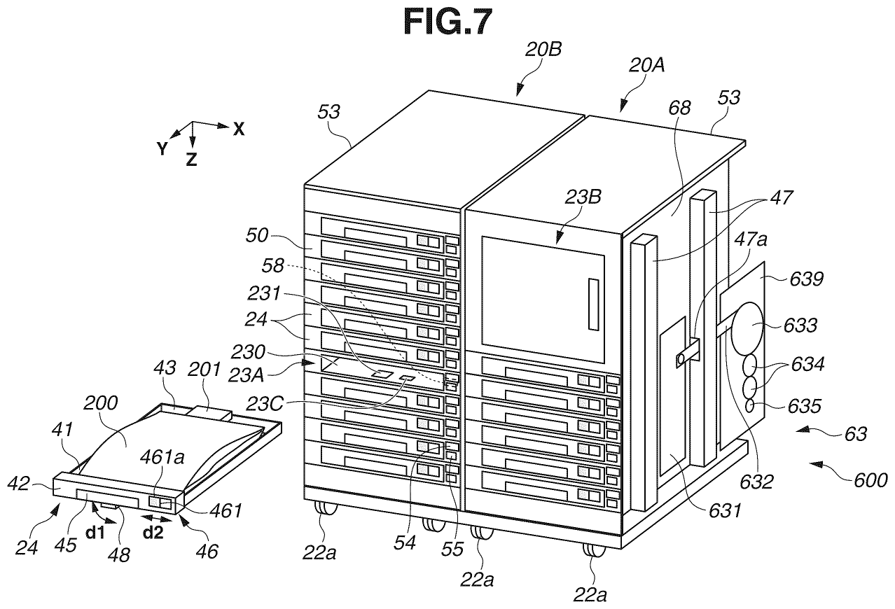

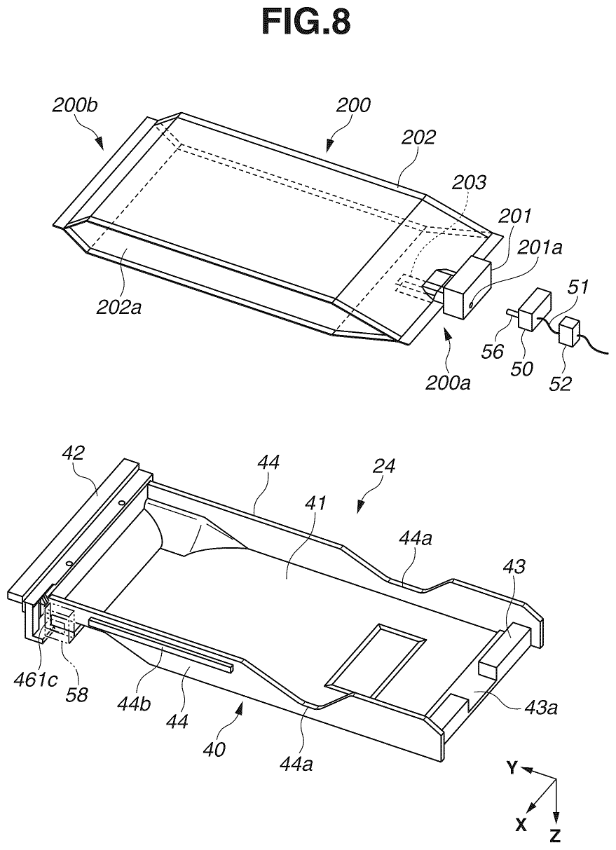

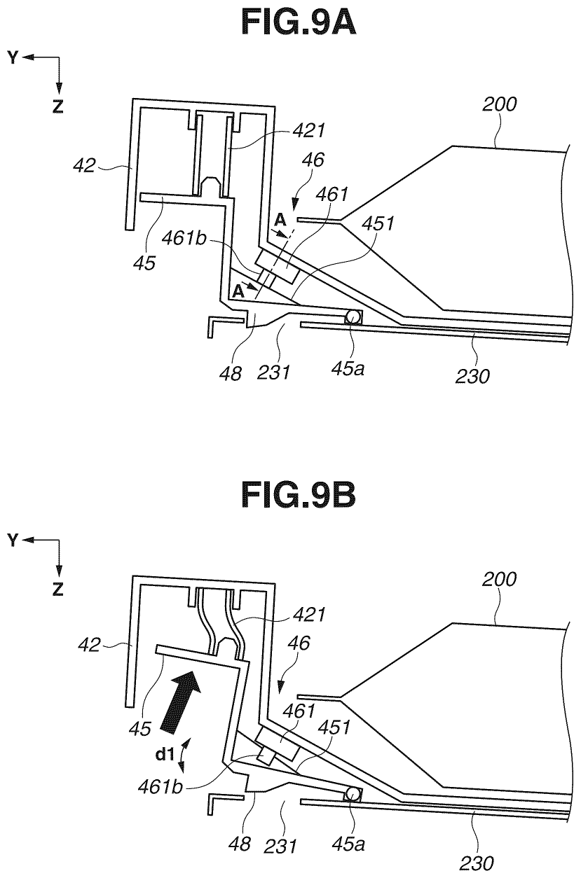

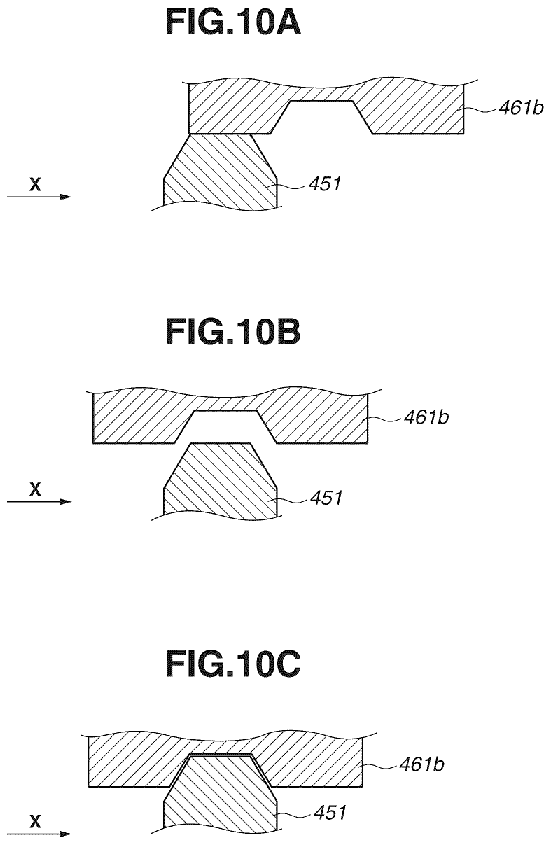

The mechanism for first agitation will be described with reference to FIGS. 7 to 10C. FIG. 7 is a partially exploded perspective view of the liquid storage apparatuses 20A and 20B, illustrating a state where one of the container support units 24 is detached from the corresponding storage section 23A. FIG. 7 also illustrates a state where some of the external wall portions of the liquid storage apparatuses 20A and 20B are removed to expose the internal mechanism. FIG. 8 is a perspective view of a container 200 and a container support unit 24. FIGS. 9A and 9B are explanatory diagrams of operation of a handle 45 and a lock mechanism 46. FIGS. 10A to 10C are explanatory diagrams of operation of the lock mechanism 46, and equivalent to cross-sectional views taken along line A-A of FIG. 9A.

The container 200 includes a bag 202 formed of a flexible material. The bag 202 has inwardly folded gusset portions 202a at both sides to increase the liquid storage capacity. The bag 202 is formed in a bag form by welding the sheets constituting the upper and lower surfaces and the sheets forming the gusset portions 202a to each other, whereby a flexible tank to accommodate liquid is formed. The gusset portions 202a are expanded when the remaining amount of liquid inside is large, and folded inward when the remaining amount of liquid inside is small, whereby the shape of the bag 202 changes depending on the amount of liquid accommodated. The bag 202 is formed of a material having a multilayered structure including a polyethylene terephthalate (PET) layer, for example. A multilayered material including an aluminum layer is advantageous for the material of the bag 202 when the liquid inside has the property of solidifying through reaction with the air or there are concerns of changes in concentration or the remaining amount due to evaporation.

The container 200 includes one end portion 200a and the other end portion 200b in the longitudinal direction. With the container 200 mounted in the liquid storage apparatus 20A or 20B, the end portion 200a is located at the far side of the liquid storage apparatus 20A or 20B, and the end portion 200b at the near side. An outlet member 201 is disposed on the end portion 200a. The outlet member 201 has a supply port 201a communicating with an intake port 203 inside the bag 202. The liquid accommodated in the bag 202 flows out through the intake port 203 and the supply port 201a. The outlet member 201 includes a spring-biased supply port opening-closing valve that opens and closes the supply port 201a. Under normal conditions (when there is no external force or the like applied), the supply port 201a is maintained closed by the supply port opening-closing valve.

The edge of the container 200 where the outlet member 201 is disposed is approximately 180 millimeters (mm) in length, for example, and the edges (side surfaces) orthogonal thereto are approximately 400 mm in length, for example. The container 200 accommodates approximately 1.5 liters (L) of liquid, for example. The edge where the outlet member 201 is located may be a long edge instead of a short edge. The bag 202 may be square, not rectangular, in plan view.

The liquid storage apparatuses 20A and 20B have a main body 53, which includes needle-like flow path forming members 56 to be inserted into the supply ports 201a at the back of the storage sections 23A. The flow path forming members 56 are provided for the respective storage sections 23A. When each flow path forming member 56 is inserted into the supply port 201a for connection, the supply port opening-closing valve is opened by the insertion of the flow path forming member 56. The flow path forming member 56 is supported by a block-shaped support member 50 and connected to a tube 51. The flow path forming member 56 forms a flow path for allowing the liquid accommodated in the bag 202 to flow out to the liquid discharge apparatus 1 that is the supply destination, whereby the liquid flowing out to the flow path forming member 56 is supplied to the liquid discharge apparatus 1 via the tube 51. An electric flow path valve 52 capable of opening and closing the flow path is disposed partway along the tube 51. The flow path valve 52 can be closed to close off the tube 51. The flow path valve 52 can be opened to open up the tube 51. The storage section 23A includes a reflective sensor 23C that detects whether a container 200 is mounted in the storage section 23A. The flow path valve 52 may be configured to switch the flow path open and closed by motor operation. A solenoid-or pinch-type electromagnetic valve may be used.

The container support unit 24 includes a support portion 40 that supports the container 200, and as a whole has the shape of a tray on which the container 200 in a horizontal position is placed. The container support unit 24 can be moved substantially in the Y direction, between an accommodation position where the container 200 is accommodated in the main body 53 and a removal position where the container 200 is exposed outside the main body 53. In FIG. 7, one of the container support units 24 is located at its removal position, and all the other container support units 24 are located at their accommodation positions. At the removal position, the container 200 can be replaced. At the accommodation position, the liquid accommodated in the container 200 can be supplied to the liquid discharge apparatus 1. In the present embodiment, the container support unit 24 at the removal position is separated from the storage section 23A. However, the removal position may be such that the end of the container support unit 24 is held within the storage section 23A, i.e., may be any position where the container 200 on the container support unit 24 can be replaced.

The support portion 40 includes a placement surface 41 where the container 200 is placed. The four sides of the placement surface 41 are defined by left and right side plates 44, a front end portion 42, and a rear end portion 43. The side plates 44 have notches 44a. The rear end portion 43 has a recess 43a where the outlet member 201 is placed. The side plates 44 have ribs 44b extended in the Y direction.

The front end portion 42 is equipped with a handle 45 that is rotatable about a shaft 45a extending in the X direction, and the user can rotate the handle 45 in a d1 direction. The handle 45 also serves as an operation handle of an engagement portion 48. The handle 45 includes the engagement portion 48, and an engagement portion 231 to engage with the engagement portion 48 is formed in the bottom of a case 230 that constitutes the storage section 23A. In the present embodiment, the engagement portion 48 is a protrusion, and the engagement portion 231 is a recess into which the engagement portion 48 is inserted. The engagement of the engagement portion 48 with the engagement portion 231 can prevent the container support unit 24 mounted in the storage section 23A and located at the accommodation position from coming out of the storage section 23A, for example, even when subjected to vibration due to the movement of the liquid storage apparatuses 20A and 20B or the like.

The handle 45 is constantly biased by an elastic member 421 toward an engagement position where the engagement portions 48 and 231 engage (the position of FIG. 9A). An example of the elastic member 421 is a coil spring. The user grips the handle 45 and rotates the handle 45 in the direction indicated by the arrow in FIG. 9B. This disengages the engagement portions 48 and 231, and the container support unit 24 inserted in the storage section 23A can be taken out from the storage section 23A.

To prevent the container support unit 24 mounted in the storage section 23A from being inadvertently taken out, a lock mechanism 46 for locking the container support 24 to the accommodation position is provided for each storage section 23A (see FIG. 7). The lock mechanism 46 includes a slide member 461 built in the front end portion 42. An operation portion 461a, which is a part of the slide member 461, is exposed from the front end portion 42 so that the user can operate the slide member 461. The slide member 461 is disposed to be movable in the direction of the arrow d2 (X direction) between a lock position where the rotation of the handle 45 in the d1 direction is restricted and an unlock position where the rotation of the handle 45 is allowed.

FIGS. 9A and 10A illustrate a state where the slide member 461 is located at the lock position. In other words, the lock mechanism 46 is in a locked state. The slide member 461 includes a contact portion 461b. The contact portion 461b makes contact with a rib-shaped contact portion 451 on the handle 45. In the state illustrated in FIGS. 9A and 10A, the slide member 461 obstructs and prevents the handle 45 from rotating in the disengaging direction. The container support unit 24 is therefore unable to be taken out of the storage section 23A.

FIG. 10B illustrates a state where the slide member 461 is located at an the unlock position. In other words, the lock mechanism 46 is in an unlocked state. In this state, the cutout in the contact portion 461b is opposed to the contact portion 451. Here, as illustrated in FIG. 10C, the contact portion 451 can enter the cutout in the contact portion 461b. This enables rotation of the handle 45 in the disengaging direction as illustrated in FIG. 9B. The container support unit 24 can thus be pulled out of the storage section 23A by the user sliding the slide member 461 to the unlock position and then operating the handle 45.

The storage section 23A includes a sensor 58 for detecting the position of the slide member 461 (see FIGS. 7 and 8). For example, the sensor 58 is an optical sensor (such as a photointerrupter) capable of detecting a detection piece 461c on the slide member 461. When the slide member 461 is located at the lock position, as illustrated in FIG. 8, the detection piece 461c falls on the detection position of the sensor 58 and is detected by the sensor 58. When the slide member 461 is located at the unlock position, the detection piece 461c does not fall on the detection position of the sensor 58 and is not detected by the sensor 58. Whether the slide member 461 is located at the lock position or the unlock position, i.e., whether the lock mechanism 46 is locked or unlocked can thus be detected based on the detection result of the sensor 58.

The opening and closing of the flow path valve 52 can be interlocked with the detection result of the sensor 58. For example, if the sensor 58 detects that that the slide member 461 is located at the unlock position when the flow path valve 52 is open, the flow path valve 52 is immediately closed in an interlocked manner with the detection.

The container support unit 24 can thereby be prevented from being pulled out of the storage section 23A with the flow path valve 52 open. If the container support unit 24 is pulled out of the storage section 23A with the flow path valve 52 open, air may get into the tube 51 via the flow path forming member 56. This can cause issues such as liquid solidification within the tube 51 and discharge failure at the discharge head 8. Closing the flow path valve 52 by immediate automatic control in an interlocked manner with the detection that the slide member 461 is located at the unlock position can prevent the intrusion of air into the tube 51.

### Tilted Slots

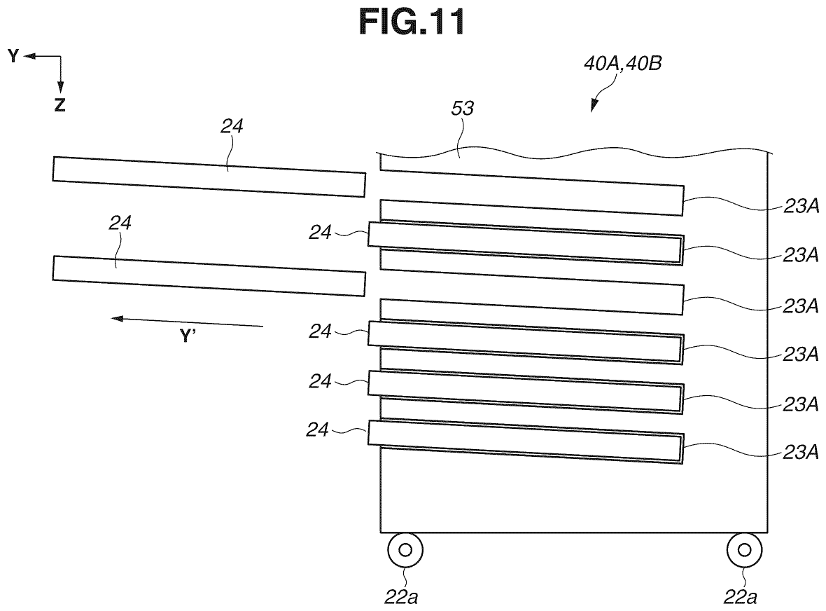

FIG. 11 is a diagram illustrating the lower part of each of the liquid storage apparatuses 20A and 20B below the storage section 23B, illustrating the mounting orientation and insertion/removal mode of container support units 24 with respect to the storage sections 23A.

As illustrated in FIG. 11, the storage sections 23A at the respective stages of the liquid storage apparatuses 20A and 20B are tilted downward (to the +Z side) toward the rear (back, −Y side).

The container support units 24 in the mounted state are thus supported in a tilted orientation. The effects thereof will be described below. For example, the tilt angle is smaller than 45°, and 10° or smaller in particular, relative to the horizontal plane. In FIG. 11, a tilt angle of 3° is assumed.

### Liquid Agitation Mechanisms

Various types of liquids can be accommodated in the containers 200 and used for image recording, maintenance of the discharge head 8, and the like. For example, aqueous inks, latex inks, and solvent-based inks such as eco-solvent can be accommodated in the containers 200. Depending on ink type, colorants, resin components, and other particles in the inks can sediment over time. Inks may vary in the particle size of the colorants and the types and amounts of additives color by color, and sedimentation velocity can differ depending on the ink color. The containers 200 can also accommodate reaction solutions to be discharged from the discharge head 8 and react with inks and fix the inks to the surface of the recording medium M. If containers 200 accommodate liquids prone to component separation, the accommodated liquids can be agitated as appropriate to improve uniformity. This contributes to suppressing deterioration in the quality of recorded images, for example.

The foregoing mechanism for first agitation physically presses the bags 202 of the containers 200 from outside to deform the bags 202. As a result, the accommodated liquids flow and are agitated within the bags 202.

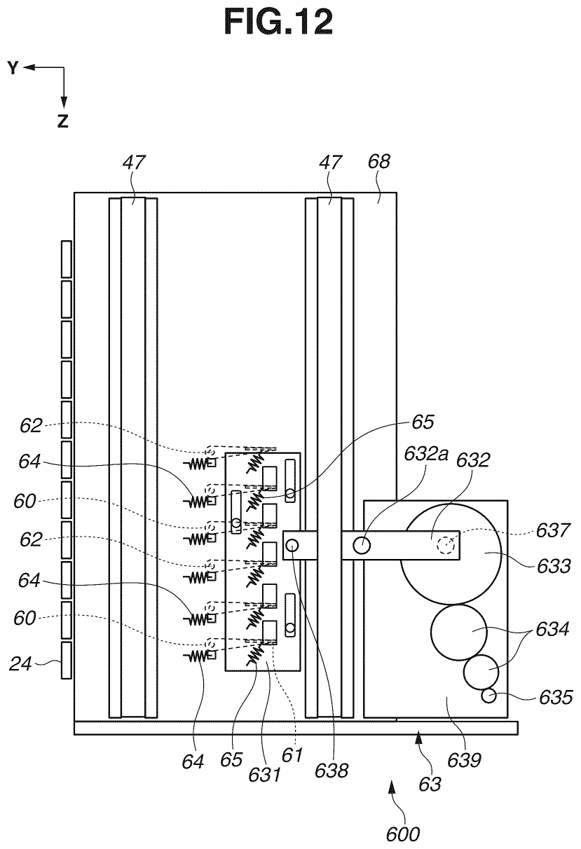

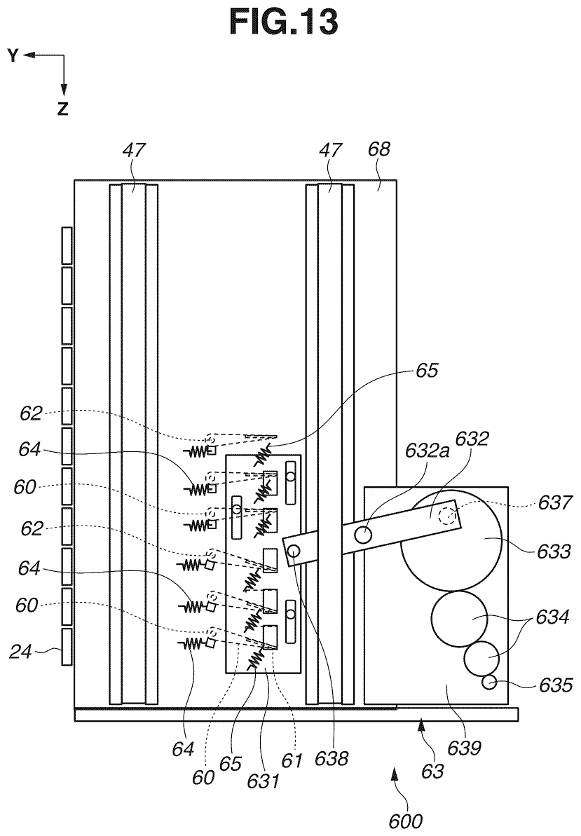

The pressing unit 600 for implementing the agitation function will be described with reference to FIGS. 7, 12, and 13. FIGS. 12 and 13 are explanatory diagrams of operation of the pressing unit 600, where the main body 53 is viewed from a side. The pressing unit 600 includes a plurality of pressing members 60 and a moving mechanism 63 common to the plurality of pressing members 60. The pressing members 60 are agitation operation units that are provided for the respective storage sections 23A and perform liquid agitation operation on the corresponding containers 200. The moving mechanism 63 is a drive unit that drives the pressing members 60. The moving mechanism 63 synchronously rotates the pressing members 60 about their rotation shafts 62, whereby pressing portions 61 of the pressing members 60 press the containers 200 from above and then release the pressure. FIG. 12 illustrates a state where the pressing portions 61 (and pressing members 60) are at a pressure relief position. FIG. 13 illustrates a state where the pressing portions 61 (and pressing members 60) are at a pressing position.

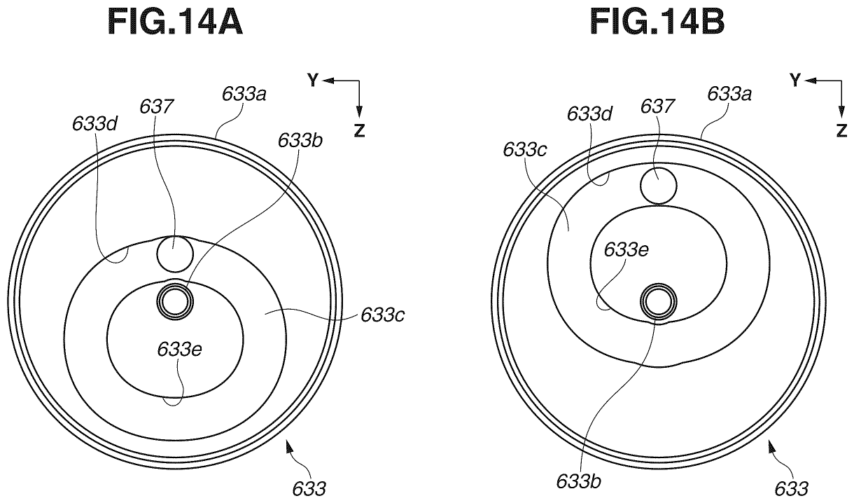

The configuration of the moving mechanism 63 will be described. The output of a motor 635 that is the drive source of the moving mechanism 63 is transmitted to a cam 633 via a plurality of gears 634. The rotation axes of these components are in the X direction. The configuration of the cam 633 will now be described with reference to FIGS. 14A and 14B. FIGS. 14A and 14B are explanatory diagrams of the cam 633. FIG. 14B illustrates a state where the cam 633 is rotated 180° from the state of FIG. 14A.

The cam 633 is a disc-shaped member rotatable about a shaft 633b extending in the X direction. Gear teeth 633a are formed on the outer periphery of the cam 633. The gear teeth 633a mesh with one of the gears 634, and the rotation of the gear 634 rotates the cam 633. A groove 633c is formed in a face of the cam 633, and the outer and inner side surfaces of the groove 633c form an outer cam surface 633d and an inner cam surface 633e. A cam follower 637 coupled to a drive transmission lever 632 is located in the groove 633c. The inner cam surface 633e lies inside the cam follower 637 in the radial direction of the cam 633. When the cam 633 rotates, the inner cam surface 633e comes into contact with the cam follower 637 and pushes up the cam follower 637. The outer cam surface 633d lies outside the cam follower 637 in the radial direction of the cam 633. When the cam 633 rotates, the outer cam surface 633d comes into contact with the cam follower 637 and pushes down the cam follower 637.

Refer to FIGS. 7, 12, and 13 again. As the cam follower 637 moves up and down due to the rotation of the cam 633, the drive transmission lever 632 rotates about a rotation shaft 632a. The drive transmission lever 632 is rotatably coupled to a shaft portion 638 provided on an elevating member 631, and the motion of the drive transmission lever 632 is converted into up-down movement of the elevating member 631. As the cam 633 makes one rotation, the cam follower 637 makes one reciprocation in the Z direction, and the elevating member 631 similarly makes one reciprocation up and down via the drive transmission lever 632.

The plate-like elevating member 631 is attached to a side plate 68 of the main body 53 to be movable up and down in the Z direction. Two columns 47, front and rear, that extend in the Z direction and have a U-shaped cross section are fixed to the side plate 68. Such columns 47 are also attached to the side plate on the-X side, and the structural strength of the main body 53 is secured by the total of four columns 47. This enables supporting the weight of a large number of containers 200.

Since the columns 47 have high strength but also have large thickness, the dimension in the X direction would become large if the moving mechanism 63 were disposed further outside of the columns 47 attached to the side plate 68 in the X direction. In the present embodiment, the elevating member 631 and the drive mechanism such as the cam 633 are therefore distributed front and rear in the Y direction across one of the columns 47. The drive transmission lever 632 is passed through a through hole 47a formed in the one column 47.

Such a configuration enables the arrangement of the moving mechanism 63 of the pressing unit 600 while securing strength and suppressing size increase of the main body 53 in the X direction. Moreover, the drive transmission lever 632 is attached to the plate-like support member 639 supporting the moving mechanism 63. With fixing elements such as fastening screws removed, most of the components of the moving mechanism 63 and the support member 639 can thus be detached as an integral unit toward the rear of the main body 53. This facilitates servicepersons' parts replacement and other operations. Configuring the fixing elements such as fastening screws to be capable of fastening from the rear of the main body 53 can facilitate fastening and unfastening.

Each pressing member 60 undergoes biasing forces from two springs 64 and 65 on each side. The spring 64 is attached at one end to the pressing member 60 and at the other end to the storage section 23A (case 230). The spring 65 is attached at one end to the pressing member 60 and at the other end to the elevating member 631. The pressing member 60 is a movable member (in particular, rotating member) rotatably attached to the storage section 23A (case 230) with rotation shafts 62 as the rotation center. The rotation shafts 62 are shafts extending in a direction intersecting the moving direction (Z direction) of the pressing unit 61. The two springs 64 and 65 both bias the pressing member 60 to rotate clockwise in FIGS. 12 and 13.

When the pressing member 60 is at the pressure relief position (FIG. 12), the elevating member 631 is in contact with the pressing member 60 and lifting up itself, and the biasing force of the spring 65 acts between the elevating member 631 and the pressing member 60. The biasing force of the spring 65 thus acts only between the elevating member 631 and the pressing member 60 and does not load the motor 635. In other words, the only load acting on the moving mechanism 63 at the pressure relief position is the biasing force of the spring 64 and the self-weight of the components.

When the pressing member 60 is at the pressing position (FIG. 13), the cam 633 is at a phase 180° opposite from the pressure relief position, and the pressing portion 61 of the pressing member 60 contacts and presses down the container 200. The pressing distance of the pressing portion 61, i.e., the amount of rotation of the pressing member 60 differs depending on the remaining level of the container 200. FIG. 13 illustrates a situation where the upper three pressing members 60 are pressing containers 200 that are full, and the lower three pressing members 60 are pressing containers 200 that are almost empty and deflated. The containers 200 are subjected to the biasing forces of both the springs 64 and 65 and the self-weight of the components. Since the springs 64 and 65 are provided for each storage section 23A, optimal pressing force can be applied to each container 200 even if the containers 200 in the respective storage sections 23A differ in the remaining level.

Here, the biasing force of the spring 64 acts on the container 200 but not on the elevating member 631. The biasing force of the spring 65 acts between the container 200 contacted via the pressing member 60 and the elevating member 631. The cam 633 serves to push down the elevating member 631 relative to the container 200. In such a manner, the load acting on the moving mechanism 63 during operation is reduced by using the two springs 64 and 65 attached at different positions and the cam 633 capable of both up and down operations.

At the pressing position, the pressing force acting on the container 200 is smaller the lower the remaining level of the container 200 and the more deflated the container 200, since the springs 64 and 65 are stretched less. When the remaining level of the container 200 is high, the container 200 being pressed exerts more reaction force and thus large pressing force may be used for deep compression. By contrast, when the remaining level is low, the reaction force from the container 200 is small and the container 200 can be easily deformed to move the liquid inside with small pressing force. The springs 64 and 65 are therefore located at positions where the pressing force decreases as the container 200 gets deflated. Such a configuration eliminates the need for the springs 64 and 65 to have excessively large biasing force. In the present embodiment, for example, the load on the pressing portion 61 is adjusted to approximately 500 gf with the container 200 full, and approximately 300 gf or so with little liquid remaining.

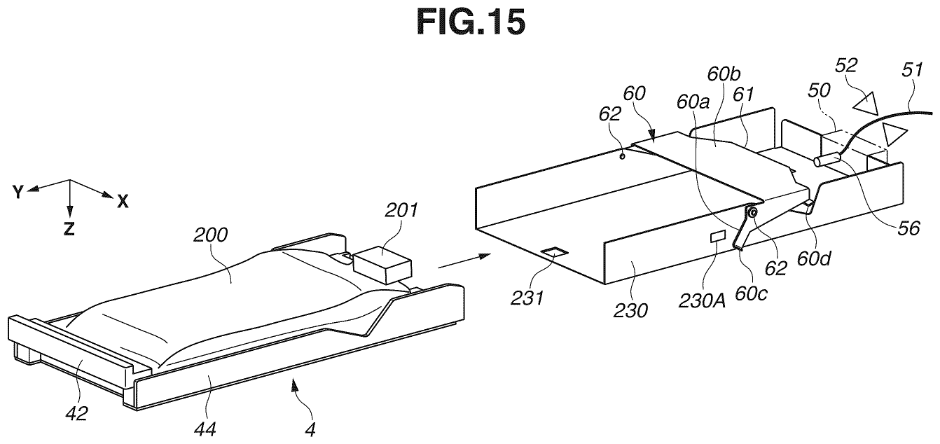

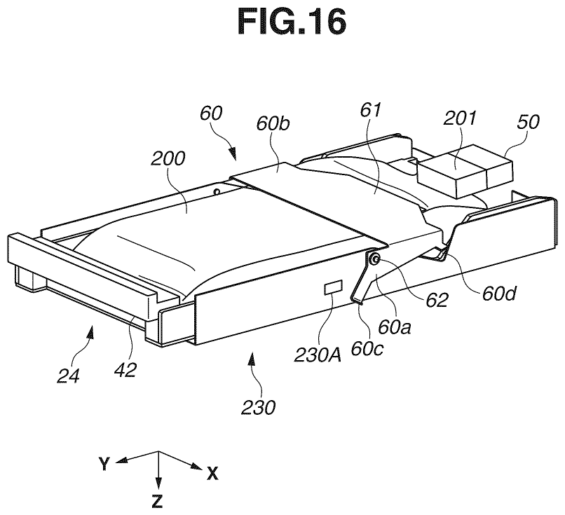

The configuration of the pressing member 60 will be described with reference to FIGS. 15 and 16. FIG. 15 is a perspective view of a case with agitation function and a support unit in a separated state. FIG. 16 is a perspective view of the case with agitation function and the support unit in a mounted state.

The pressing member 60 includes a pair of side plates 60a located at respective sides of the case 230 in the X direction, and a top plate 60b connecting the pair of side plates 60a to straddle the case 230 in the X direction. The pressing member 60 is rotatably supported by the case 230 at the side plates 60a via the rotation shafts 62. The pressing portion 61 is formed at the end of the top plate 60b.

Each side plate 60a includes a locking portion 60c to which an end of the spring 64 is locked, and a contact portion 60d to which an end of the spring 65 is locked and that comes into contact with the elevating member 631 and rotates the pressing member 60 when the elevating member 631 moves up. The locking portion 60c and the contact portion 60d are both formed as protruding pieces protruding in the X direction.

A remaining level detection sensor 230A is disposed on a side portion of the case 230. The remaining level detection sensor 230A is an optical sensor, for example. The remaining level detection sensor 230A is a position detection sensor that detects the side plate 60a to detect the position of the pressing portion 61 and detects the remaining level of the container 200 from the result of position detection. Specifically, the remaining level detection sensor 230A is configured so that its detection position is located where the side plate 60a is detected when the container 200 deflated due to low remaining level is pressed. This utilizes the fact that the pressing stroke varies depending on the degree of deflation of the container 200. In the present embodiment, the pressing portion 61 is brought into contact with the container 200, and the position of the side plate 60a reflects the remaining level of the container 200. The accuracy of remaining level detection is thus high. For example, the detection position of the remaining level detection sensor 230A is designed so that the side plate 60a is detected when the container 200 is pressed with approximately 100 ml of liquid remaining.

The pressing member 60 can be formed of a metal plate (such as steel plate), for example. Since even thin metal plates have high strength compared to resin members and the like, the height of the storage section 23A can be reduced. The rotation shafts 62 of the pressing member 60 are located outside the container 200 in the X direction so that the rotation shafts 62 and the container 200 overlap in the X direction when the container 200 is full. With such contrivances to reduce the size in the Z direction, multiple stages of containers 200 can be accommodated within the limited space under the housing of the system A despite the provision of the storage sections 23A with the respective pressing members 60 for the agitation function.

The width of the pressing member 60 in the X direction is smaller at the pressing portion 61 than that near the rotation shafts 62. This prevents portions other than the pressing portion 61 from contacting the container 200 when the pressing portion 61 presses the container 200, whereby damage to the container 200 can be prevented.

The configuration that the pressing member 60 has a smaller width in the X direction at the pressing portion 61 than that near the rotation shafts 62 also has the following advantage. The container 200 has the gusset portions 202a at the sides as described above. The gusset portions 202a include the welded portions of flexible members and have higher rigidity than those of the other portions. A considerable pressing force may be used to collapse the container 200 by folding the gusset portions 202a inward as the remaining level decreases. When the remaining level of the container 200 is high, the gusset portions 202a are vertically expanded and may even be inflated outward, not inward. To collapse the gusset portions 202a may use a considerable pressing force.

Locating the pressing portion 61 inside the gusset portions 202a in the X direction enables efficient pressing and deformation of the container 200 for agitation. More specifically, the pressing portion 61 is located to press the central part of the container 200 than the gusset portions 202a, and the container 200 is pressed in its most inflated part. The gusset portions 202a at both sides have a height of approximately 20 mm, and the pressing portion 61 located inside the gusset portions 202a at both sides is less affected by reaction force from the gusset portions 202a and can efficiently press the container 200. For higher pressing efficiency, the width of the pressing portion 61 in the X direction can be designed to a size that falls within 10 mm or more inside. The reason is that the large distances from the gusset portions 202a in the X direction further reduce the effect of the reaction force from the gusset portions 202a.

As an example of a configuration that minimizes the width of the pressing member 61 in the X direction, the pressing member 61 may be configured to make a point contact with the container 200. However, when the container 200 has a shape long in the Y direction as in the present embodiment, the pressing portion 61 configured to make a point contact with the container 200 can result in low fluidity of the liquid in the container 200. Specifically, if the width of the pressing portion 61 in the X direction is too small, the flow of the liquid displaced by the pressing of the container 200 is also dispersed outward in the X direction, and the amount of liquid flow in the Y direction decreases accordingly.

In view of this, for example, the fluidity of the liquid within the bag 202 of the container 200 in the Y direction can be improved by configuring the width of the pressing portion 61 in the X direction to be one third or more of that of the bag 202 of the container 200 in the X direction. For example, when the width of the bag 202 in the X direction is 180 mm, the width of the pressing portion 61 in the X direction can be set to 60 mm or more for improved fluidity of the liquid within the bag 202 in the Y direction during pressing.

In summary, when the width of the bag 202 in the X direction is 180 mm and the gusset portions 202a have a height of 20 mm, the suitable width of the pressing portion 61 in the X direction is 60 mm to 120 mm, and may be 90 mm in particular.

### Agitation Operation

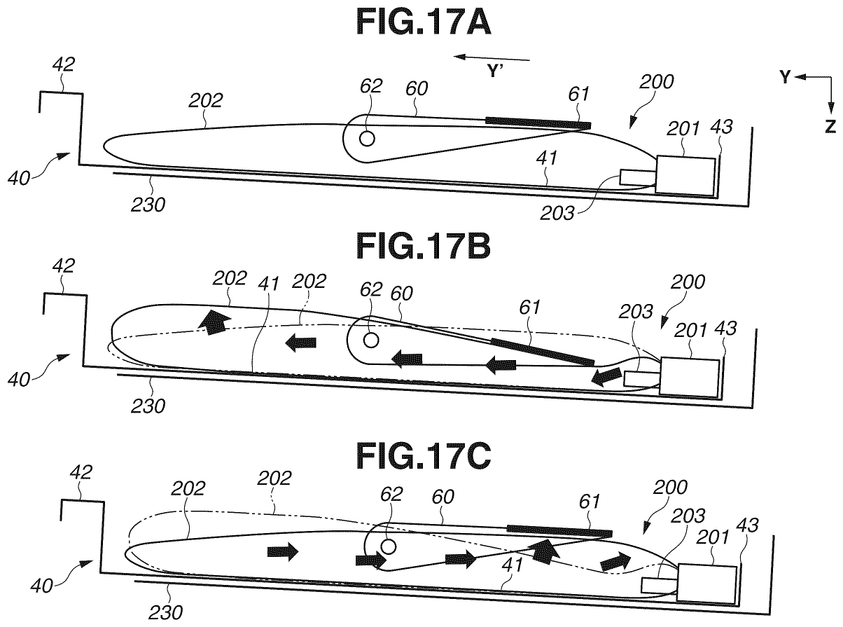

The agitation operation of the liquid within the container 200 through pressing of the container 200 by the pressing portion 61 will be described with reference to FIGS. 17A to 17C. FIGS. 17A to 17C are explanatory diagrams of the agitation operation. As illustrated in FIG. 11, in the present embodiment, the mounting orientation of the container support unit 24 is tilted. In FIGS. 17A to 17C, the direction of the tilt angle of this mounting orientation is represented by a Y′ direction. In the following description, the outlet member 201-side of the container 200 may be referred to as a −Y′ direction, and the opposite side as a +Y′ direction. The thick arrows in FIGS. 17A to 17C indicate the direction of the liquid flow occurring within the bag 202 of the container 200.

In the present embodiment, the agitation operation includes a pressing operation and a pressure relief operation. The pressing portion 61 is opposed to the placement surface 41 of the container support unit 24. The pressing portion 61 is reciprocated between the pressure relief position and the pressing position. By such operation, the bag 202 is deformed to produce internal liquid flow for agitation.

FIG. 17A illustrates a state where the pressing portion 61 (and pressing member 60) is at the pressure relief position. In the present embodiment, the pressing portion 61 at the pressure relief position is located at a height where the pressing portion 61 is separated from the placement surface 41 and does not contact the bag 202, and is not pressing the bag 202. The pressure relief position can thus be referred to as a pressure release position.

From the state of FIG. 17A, the moving mechanism 63 is driven to perform a pressing operation as illustrated in FIG. 17B. In the pressing operation, the pressing member 60 rotates to move the pressing portion 61 to a position closer to the placement surface 41 than the pressure relief position, whereby the bag 202 is pressed toward the placement surface 41. This deforms the bag 202 and causes the liquid inside to flow for agitation.

In the present embodiment, the container 200 is mounted in the storage section 23A as tilted with the outlet member 201 downward in the Z direction. In the phase of FIG. 17A, the liquid in the container 200 therefore tends to be unevenly distributed toward the outlet member 201 by its own weight, and the bag 202 bulges more on the outlet member 201-side than at the midsection in the Y′ direction. The pressing portion 61 is designed to press the vicinity of the end portion 43 where the outlet member 201 is disposed, between the end portions 42 and 43 of the container 200. Since the pressing portion 61 presses the bulging part of the bag 202 or its vicinity, the liquid flow within the bag 202 can be promoted.

Since the pressing unit 61 presses the bag 202 near the outlet member 201, agitation can be efficiently performed if the liquid flows to the other side. The rotation shafts 62 of the pressing member 60 are located on the side of the pressing portion 61 opposite to the outlet member 201 in the Y′ direction of the container 200. During the pressing operation, the rotation direction of the pressing member 60 is clockwise in FIG. 17B. Such a rotation direction setting produces a vector in the +Y′ direction and facilitates the liquid flow in the +Y′ direction. In other words, the liquid flows easily to the side opposite to the outlet member 201-side in the bag 202.

As described above, in the present embodiment, the pressing portion 61 is designed to press the vicinity of the end portion 43 where the outlet member 201 is disposed, between the end portions 42 and 43 of the container 200. The bag 202 is pressed in the vicinity of the intake port 203 of the container 200, and the liquid agitation in this vicinity is particularly promoted. During recording, the liquid in the container 200 flows out from the vicinity of the intake port 203 to the tube 51. Pressing the vicinity of the intake port 203 for agitation can feed liquid of more uniform concentration into the tube 51.

From the state of FIG. 17B, the moving mechanism 63 is driven to perform a pressure relief operation as illustrated in FIG. 17C. In the pressure relief operation, the pressing member 60 is rotated to restore the pressing portion 61 from the pressing position to the pressure relief position. With the pressure relieved, the liquid within the bag 202 flows and the bag 202 tends to restore its original shape. Then, the pressing operation can be performed again.

The liquid within the bag 202 is agitated by repeating the pressing operation and the pressure relief operation. More specifically, when the pressing portion 61 is located at the pressing position as illustrated in FIG. 17B, the container 200 is depressed in the vicinity of the pressing portion 61, the liquid flows in the +Y′ direction, and the container 200 bulges at the side opposite to the outlet member 201. Subsequently, when the pressure is relieved as illustrated in FIG. 17C, the liquid flowed by pressing flows back in the −Y′ direction by its own weight. With the pressing operation and the pressure relief operation repeated, the liquid within the bag 202 reciprocates in the Y′ direction and is agitated. The liquid flow produced by the pressure relief operation utilizes the liquid's own weight. The use of the own weight can simplify the configuration of the mechanism for liquid agitation.

In repeating the agitation operation, the liquid agitation performance (agitation efficiency) can be adjusted by means of cycles. In the pressure relief operation, the liquid within the bag 202 flows with some delay after the rotation of the pressing member 60. The higher the fluidity of the liquid during the pressure relief operation, the higher the agitation efficiency.

After sufficient liquid flow, the amount of liquid accommodated in the bag 202 increases and the bag 202 bulges out in the vicinity of the pressing portion 61. Pressing this part can thus enhance the agitation efficiency. The agitation operation cycle is slower than several hertz, for example, and slower than 1 Hz in particular. If the agitation operation cycle is too slow, the total duration of the agitation operation increases and the power consumption of the motor 635 may increase. The agitation operation can thus be set to the range of 0.5 to 0.7 Hz, or 0.6 Hz in particular.

As the remaining level decreases and the container 200 becomes deflated, the amount of liquid accommodated in the upper part of the tilted container 200 (+Y′ side) decreases because the liquid flows to the −Y′ side by its own weight. On the other hand, the liquid accumulates in the lower part (−Y′ side). In such a state, the flowing distance of the liquid in the +Y′ direction during the pressing operation decreases, and the time for the liquid to return during the pressure relief operation is short. The agitation operation cycle can thus be reduced as the remaining level of the container 200 decreases.

In the agitation operation, the pressing operation and the pressure relief operation may be repeated to leave a time interval between the pressure relief operation and the next pressing operation. This can allow for a longer flow time for the liquid within the bag 202 after the pressure relief operation until the start of the next pressing operation, whereby the liquid flow by its own weight can be further promoted.

There are several techniques or methods for adjusting the agitation operation cycle. One method uses the dwell angles, which are the ranges where the cam follower 637 in contact with the inner cam surface 633e or the outer cam surface 633d does not move despite the rotation of the cam 633. For example, the dwell angle at the position where the cam follower 637 is at its highest point is set to 40°, and the dwell angle at the position where the cam follower 637 is at its lowest point is also set to 40°. In particular, securing a dwell angle of 40° at the highest point can hold the pressure relief position.

Allocation angles that are respective angle ranges for raising and lowering the cam follower 637 may be set as large as 140° each. This reduces the rotating load of the cam 633 and causes the connected pressure member 60 to transition gently from the pressing state to the pressure relief state, whereby the effect of securing time for the liquid to move to the vicinity of the pressing portion 61 is obtained. As a result, the liquid moves sufficiently during pressure relief for enhanced agitation effect.

Another method is to temporarily stop the motor 635 at the pressure relief position. Implementing durations equivalent to the foregoing dwell angles of 40° by stopping the motor 635 can reduce the dwell angles and increase the allocation angles. This can further reduce the load during cam rotation.

The agitation operation may be performed at any timing, including during the supply operation of liquid to the liquid discharge apparatus 1, during the recovery operation of the discharge head 8 in the liquid discharge apparatus 1, and during standby for a recording operation. The timing of the agitation operation is basically not affected by the operation of the liquid storage apparatuses 20A and 20B or the liquid discharge apparatus 1.

The agitation period in which the agitation operation is repeated may be set with reference to time or with reference to the number of operations. For example, with several tens of minutes as a session, the agitation operation may be repeated for only one session a day. The desired agitation period and execution timing may be set in consideration of the sedimentation velocities of the colorants in the liquids.

Referring to FIG. 11, with the containers 200 and the container support units 24 mounted in the storage sections 23A as described above, these components are tilted relative to the horizontal plane. In view of the liquid agitation effect, the tilt angle is advantageously smaller than 45°, more advantageously 10° or smaller. In the example of FIG. 11, a tilt angle of 3° is assumed.

The agitation by pressing can be performed even at tilt angles near 90°, whereas the liquid's own weight acts in the direction against the liquid flow produced by the pressing. This may involve stronger pressing force to produce sufficient liquid flow. At tilt angles smaller than 45°, the vector of the liquid flow in the −Y direction due to the liquid's own weight becomes relatively small. At tilt angles of 10° or smaller, a large amount of bulging can be obtained on the +Y side of the bag 202 during the pressing operation even with small pressing force. The larger the amount of bulging of the bag 202 during pressing, the larger the amount of internal liquid flow. This means favorable agitation efficiency by pressing.

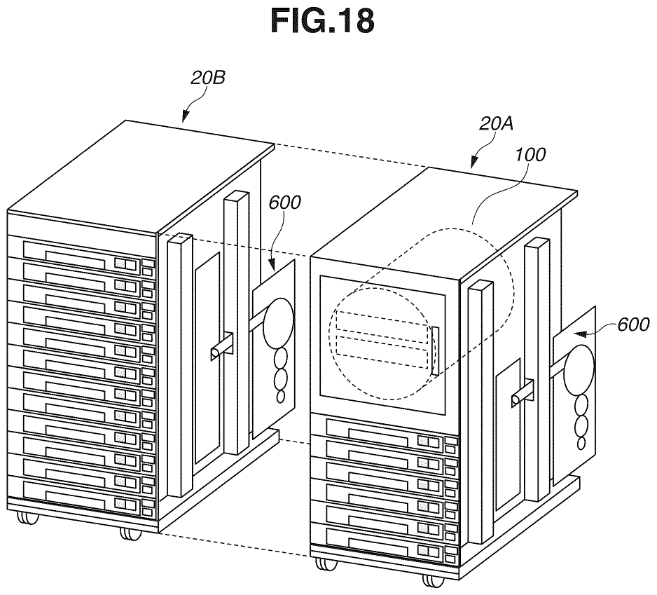

FIG. 18 is a perspective view illustrating the liquid storage apparatus 20A and the liquid storage apparatus 20B separated. As illustrated in FIG. 18, the liquid storage apparatus 20A and the liquid storage apparatus 20B include respective pressing units 600 that are the mechanisms for first agitation of the same configuration. The liquid storage apparatus 20B includes ten stages for spot colors, which may use the agitation function, and a single stage for the clearing liquid, which does not need the agitation function. Ten stages of pressing members 60 and springs 64 and 65 are therefore provided, while the number of stages is six in FIGS. 12 and 13. In other respects, the configuration of the pressing units 600 is common between the liquid storage apparatuses 20A and 20B.

With such a configuration, the liquid storage apparatus 20A and the liquid storage apparatus 20B can perform ink agitation operations independently. Since the pressing units 600 have similar configurations, common parts can be used for a reduction in device cost.

In the present embodiment, the pressing portion 61 at the pressure relief position is located at a height to not contact the bag 202. However, the pressing portion 61 may be in contact with the bag 202, or located at a position where the pressing unit 61 presses the bag 202 by a smaller amount than at the pressing location. Such a small-press state at the pressure relief position can lower the upper limit position of the pressing member 60 in the Z direction, and can reduce the dimension of the liquid storage apparatuses 20A and 20B in the Z direction.

In the present embodiment, the pressing member 60 is disposed on the case 230 of the storage section 23A. However, the pressing member 60 may be disposed on the container support unit 24. In such a case, a configuration that enables drive transmission between the moving mechanism 63 and the pressing member 60 when the container support unit 24 is mounted in the storage section 23A may be added.

The present embodiment has dealt with the configuration where the container 200 is pressed by the pressing portion 61. However, the container 200 may be deformed by applying and stopping compressed air repeatedly. The space around the container 200 may be pressurized and depressurized to deform the container 200.

### Mechanism for Second Agitation

Various types of liquids can be accommodated in the containers 200 and used for image recording, maintenance of the discharge head 8, and other purposes. Depending on ink type, the colorant (such as pigment) in the ink can sediment over time. For example, pigments with high water resistance and lightfastness, and titanium oxide used as white ink pigment in particular, do not dissolve in water and thus sediment, accumulate, and aggregate at the bottom of the container 200 due to gravity when left standing for a long period of time. To develop desired color, agitation may be used to uniformly disperse the foregoing components in the liquid while maintaining a predetermined particle diameter. In the present embodiment, the provision of the liquid agitation device 100 enables agitation of such liquid to disperse the particles for improved uniformity. In particular, the liquid agitation can be automated to reduce the burden on the user.

### Device Overview

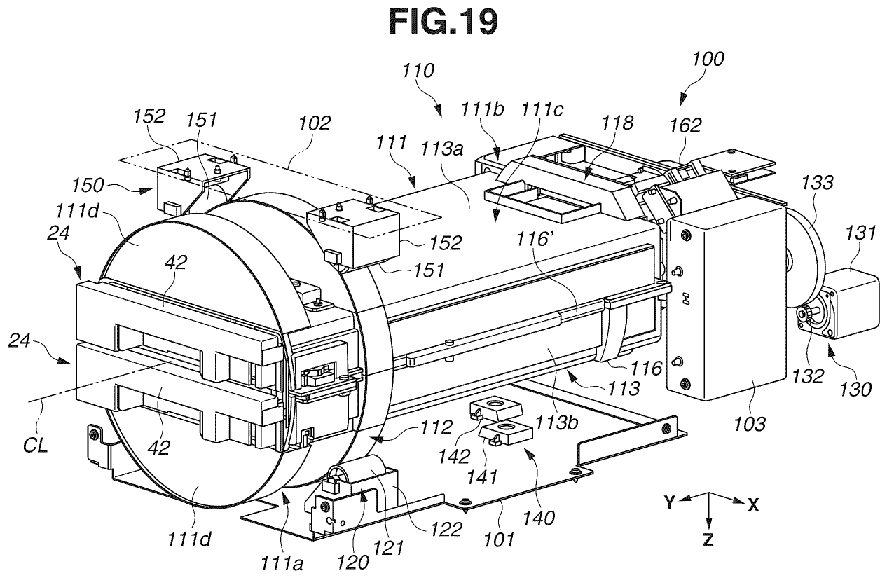

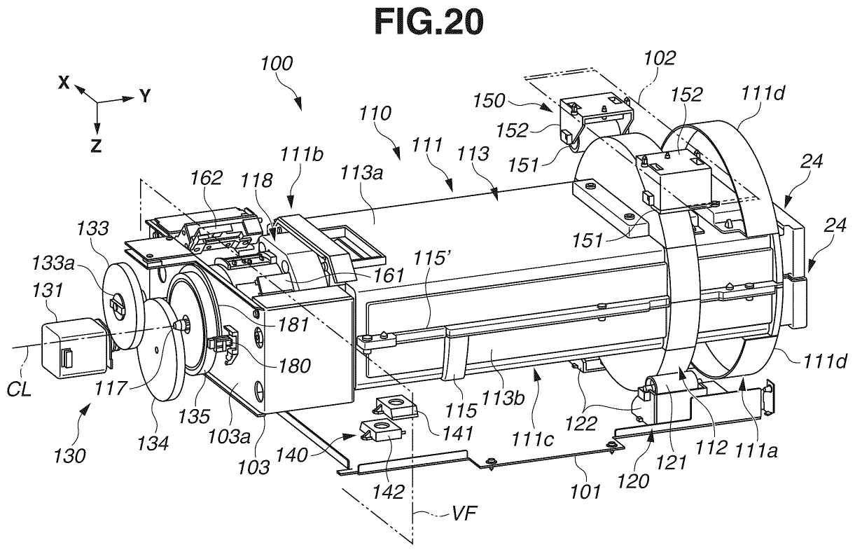

FIGS. 19 and 20 are perspective views of the liquid agitation device 100. Specifically, FIG. 19 is a perspective view of the liquid agitation device 100 seen from the front. FIG. 20 is a perspective view of the liquid agitation device 100 seen from the rear. The liquid agitation device 100 includes an accommodation unit 110 that accommodates liquid, a support unit 120 that rotatably supports the accommodation unit 110, and a drive unit 130 that rotates the accommodation unit 110 supported by the support unit 120. These components are supported by the main body 22 of the liquid storage apparatus 20A via frames including frames 101 to 103.

In the present embodiment, the liquid accommodated in the accommodation unit 110 is agitated by rotating the accommodation unit 110 about a rotation centerline CL illustrated by the imaginary line. Rotating the accommodation unit 110 enables more effective liquid agitation. The rotation centerline CL is a line passing through the accommodation unit 110. In the present embodiment, the direction of the rotation centerline CL is the Y direction.

In the present embodiment, the accommodation unit 110 is configured so that two container support units 24 can be inserted into and removed from the accommodation unit 110 at the front side. The liquid in the two containers 200 can thereby be agitated at the same time. The two container support units 24 are mounted in the accommodation unit 110 in vertically stacked two stages. The number of container support units 24 mountable may be three or more, or one.

The drive unit 130 is located behind the accommodation unit 110 to allow for a relatively large space in front of the accommodation unit 110. This improves the user's ease of insertion and removal of the container support units 24 into/from the accommodation unit 110. The entire liquid agitation device 100 is configured to extend in the Y direction, whereby the size of the liquid agitation device 100 in the X direction can be reduced.

### Accommodation Unit

The accommodation unit 110 will be described with reference to FIGS. 19 and 20. The accommodation unit 110 includes an accommodation member 111 and a shaft fixing member 118 that are coupled in the direction of the rotation centerline CL.

The accommodation member 111 is a hollow member for accommodating the containers 200. The accommodation member 111 includes a front end portion 111a that is one end in the direction of the rotation centerline CL (Y direction) and a rear end portion 111b that is the other end. An outer wall portion 111c of the accommodation member 111 between the front end portion 111a and the rear end portion 111b is constituted by a circular cylindrical portion 112 and a rectangular cylindrical portion 113. The circular cylindrical portion 112 is located closer to the front end portion 111a than the rear end portion 111b. The rectangular cylindrical portion 113 is located on both the front end portion 111a-side and the rear end portion 111b-side of the circular cylindrical portion 112. The circular cylindrical portion 112 has a circular cylindrical outer periphery. The rectangular cylindrical portion 113 has a substantially rectangular cylindrical shape. In a front view of the liquid agitation device 100, sectorial cover members 111d for covering components behind the front end portion 111a are attached to the front end portion 111a.

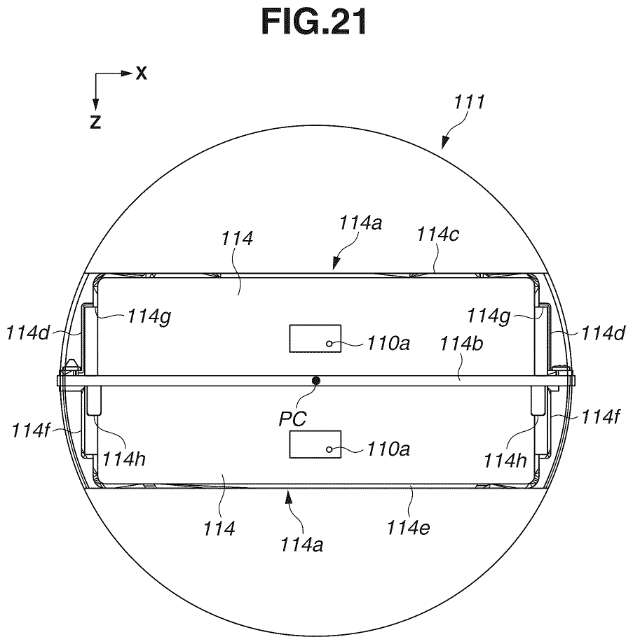

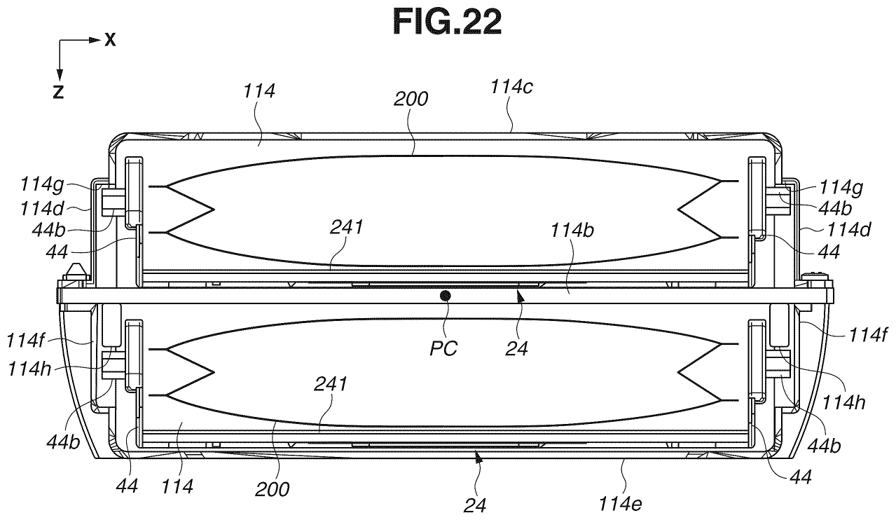

The accommodation unit 110 will be further described with reference to FIGS. 21 and 22 in addition to FIGS. 19 and 20. FIG. 21 is a front view of upper and lower accommodation spaces 114 formed by the accommodation member 111, illustrating a state where the container support units 24 are removed from the accommodation spaces 114. FIG. 22 is also a front view of the upper and lower accommodation spaces 114, illustrating a configuration (sectional shape) where the container support units 24 are accommodated in the accommodation spaces 114. The accommodation spaces 114 are formed throughout the circular cylindrical portion 112 and the rectangular cylindrical portion 113. In the following description, direction-related items are described on the assumption that the accommodation unit 110 is at its initial position, unless otherwise specified.

The internal space of the accommodation member 111 is partitioned into upper and lower two stages by a partition wall 114b extending in the X and Y directions, whereby the accommodation spaces 114 along the rotation centerline CL are formed above and below the partition wall 114b. An opening 114a serving as the access port of the accommodation spaces 114 is formed in the front end portion 111a of the accommodation member 111.

The container support units 24 can be moved in the Y direction between the accommodation position where the containers 200 are accommodated in the accommodation spaces 114 and the removal position where the containers 200 are exposed outside the accommodation unit 110. Since the containers 200 can be replaced at the removal position, the liquid replenishment operation can be quickly performed, and the container support units 24 can be repeatedly used. Moreover, in the present embodiment, the containers 200 can be replaced with high operability since there are few structures near the opening 114a that obstruct the replacement operation.

In the present embodiment, the container support units 24 at the removal position are separated from the accommodation spaces 114. However, the removal position may be where the ends of the container support units 24 are held inside the accommodation spaces 114, and may be any position where the containers 200 can be replaced with respect to the container support unit 24.

The accommodation spaces 114 are closed at the back (the end portion 111b-side of the accommodation member 111), and needle members 110a are protruded in the Y direction from the wall portion. The needle members 110a are inserted into the supply ports 201a of the container support units 24 when the container support units 24 are inserted in the accommodation spaces 114. The insertion of the needle members 110a into the supply ports 201a forms the flow paths for allowing the liquid accommodated in the bags 202 supported by the container support units 24 to flow out to the liquid discharge apparatus 1 that is the supply destination.

The accommodation spaces 114 of the present embodiment are flat rectangular parallelopiped spaces extended in the Y direction with the height in the Z direction smaller than the width in the X direction. The accommodation space 114 may be flat rectangular parallelopiped spaces extended in the Y direction with the height in the Z direction greater than the width in the X direction.

The upper accommodation space 114 is defined by a top wall 114c, left and right side walls 114d, and the partition wall 114b serving as a bottom wall. The lower accommodation space 114 is defined by a bottom wall 114e, left and right side walls 114f, and the partition wall 114b serving as a top wall. Engagement portions equivalent to the engagement portion 231 for holding the container support unit 24 at the accommodation position described with reference to FIG. 9 can be formed in the partition wall 114b serving as the bottom wall of the upper accommodation space 114 and in the bottom wall 114e of the lower accommodation space 114.

Guide portions 114g are formed on both the left and right side walls 114d of the upper accommodation space 114. The guide portions 114g have a cross-sectional shape with a stepped or sloped shoulder shape, and are extended in the Y direction. In inserting and removing a container support unit 24 into/from the accommodation space 114, the guide portions 114g function as rails that make sliding contact with the ribs 44b of the container support unit 24, and guide the movement of the container support unit 24 in the insertion and removal direction. Moreover, the guide portions 114g abut against the ribs 44b in a direction (at the initial position, Z direction) intersecting the direction of the rotation centerline CL and restrict the movement of the container support member 24 in this intersecting direction. This can prevent the container support unit 24 from rattling within the accommodation space 114 when the accommodation unit 110 rotates.

Similarly, guide portions 114h are formed on both the left and right side walls 114f of the lower accommodation space 114. The guide portion 114h have a protruding shape protruding downward from the partition wall 114b, and are extended in the Y direction. In inserting and removing a container support unit 24 into/from the accommodation space 114, the guide portions 114h function as rails that make sliding contact with the ribs 44b of the container support unit 24, and guide the movement of the container support unit 24 in the insertion and removal direction. Moreover, the guide portions 114h abut against the ribs 44b in a direction (at the initial position, Z direction) intersecting the direction of the rotation centerline CL and restrict the movement of the container support unit 24 in this intersecting direction. This can prevent the container support unit 24 from rattling within the accommodation space 114 when the accommodation unit 110 rotates.

A rotation center PC of the accommodation unit 110 is located on the partition wall 114b. The rotation center PC is a given point on the rotation centerline CL. With the configuration of the present embodiment, the rotation centerline CL passes between the two accommodation spaces 114. This enables the accommodation unit 110 to more evenly agitate the liquid in the two containers 200.

### Rotation Support Mechanism

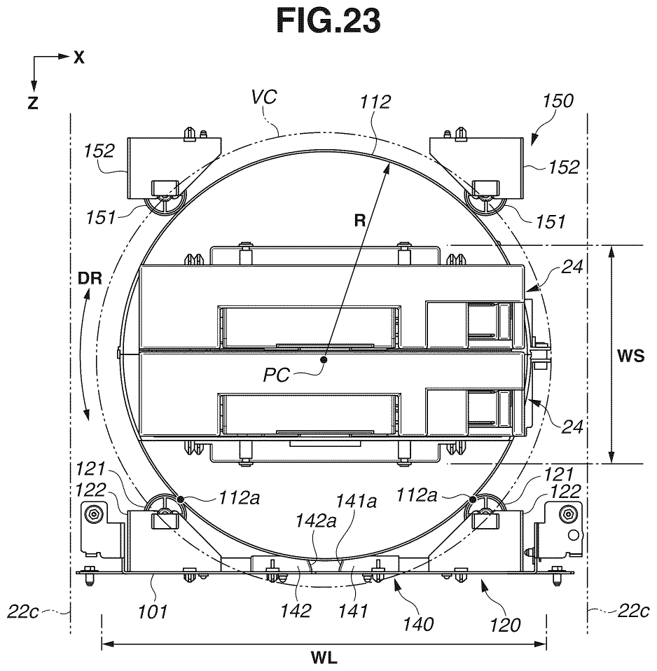

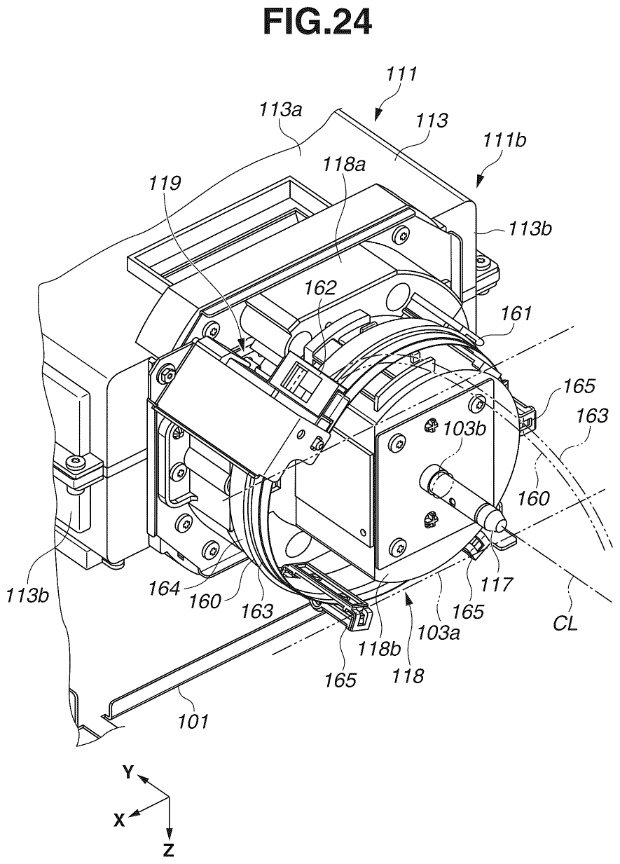

A structure for rotatably supporting the accommodation unit 110 will be described with reference to FIGS. 19, 20, 23, and 24. FIG. 23 is a front view of the liquid agitation device 100, mainly illustrating a rotation support structure of the accommodation unit 110. FIG. 24 is a perspective view illustrating a rear part of the accommodation unit 110 with the drive unit 130 detached.

Issues regarding the structure that rotatably supports the accommodation unit 110 will be described. If the accommodation unit 110 is equipped with shafts at both ends on the rotation centerline CL, the presence of the shafts and bearings may lower the freedom of design or reduce user convenience. For example, in a structure where the container support units 24 are inserted into and removed from the accommodation unit 110 as in the present embodiment, the insertion/removal positions and the insertion/removal directions can be limited. Moreover, if the structure accommodates and agitates a large amount of liquid, the rigidity of the shafts and bearings may be reinforced in consideration of the weight of the liquid.

In the present embodiment, these issues can be solved by combining the support unit 120, which is a shaftless support structure, with a shafted support structure (shaft member 117 and bearing member 103a to be described below).

The support unit 120 is a mechanism that makes contact with the outer wall portion 111c of the accommodation unit 110 and rotatably supports the accommodation unit 110. The support unit 120 of the present embodiment supports the accommodation unit 110 rotatably about the rotation centerline CL by a plurality of contact portions 121 making contact with the circular cylindrical portion 112 of the accommodation member 111. In the present embodiment, the support unit 120 includes two contact portions 121. The two contact portions 121 contact the circular cylindrical portion 112 at contact positions 112a that are located apart from each other in the circumferential direction of the circular cylindrical portion 112.

The contact portions 121 of the present embodiment are rollers supported by bearings 122 about respective axes in a direction (Y direction) parallel to the rotation centerline CL. The bearings 122 are supported by the frame 101. With the peripheral surfaces of the contact portions (rollers) 121 in contact with the circular cylindrical portion 112, the accommodation unit 110 placed between the two contact portions (rollers) 121 can rotate in place in the direction of the arrow DR in FIG. 23. Since the accommodation unit 110 is supported by the two contact portions 121 from below, structural stability can be secured without needing significant reinforcement in rigidity even if the accommodation unit 110 accommodates a large amount of liquid and is heavy in weight.

The circular cylindrical portion 112 is formed closer to the front end portion 111a of the accommodation member 111 than the rear end portion 111b, and the support unit 120 rotatably supports the accommodation unit 110 at the position closer to the front end portion 111a than the rear end portion 111b. The accommodation unit 110 is supported by the shaftless support unit 120 near the opening 114a serving as the access port through which the container support units 24 are inserted into and removed from the accommodation spaces 114. This can improve the convenience of the insertion and removal operations of the container support units 24 by the user since there is no shaft or bearing in front of the liquid agitation device 100. The vicinity of the opening 114a may be subject to loads in the gravitational direction due to the insertion and removal operation of the container support units 24. Since the two contact portions 121 support the accommodation unit 110 from below in the vicinity of the opening 114a, such loads can be stably received.

The structure in which the accommodation member 111 includes the circular cylindrical portion 112 and the rectangular cylindrical portion 113 can reduce weight and decrease the rotational moment of inertia compared to when the entire accommodation member 111 is formed of a circular cylindrical portion 112. The rectangular cylindrical portion 113 includes long side portions 113a and short side portions 113b that constitute the rectangular outline. In the present embodiment, the width WL of the long side portions 113a, the width WS of the short side portions 113b, and the radius R of the circular cylindrical portion 112 have the relationship of WL>WS and WS<2×R. Making the width WS of the rectangular cylindrical portion 112 smaller than the diameter (2×R) of the circular cylindrical portion 113 enables weight reduction and a decrease in the rotational moment of inertia.

Meanwhile, there holds a relationship of WL>2×R, and the circular cylindrical portion 112 and the contact positions 112a fall within an imaginary circle VC that passes through the outermost portions of the accommodation unit 110 and is centered on the rotation center PC. This enables miniaturization of the liquid agitation device 100. Since the side walls 22c of the storage section 23B can be located closer to the accommodation unit 110, the liquid agitation device 100 can be reduced in size in the X direction.

The shaft member 117 is disposed on the rear part (rear end portion 111b-side) of the accommodation unit 110. The shaft member 117 is fixed to an end portion of the shaft fixing member 118 and extended on the rotation centerline CL. The shaft fixing member 118 is a hollow body including a flange portion 118a fixed to the rear end portion 111b of the accommodation member 111 and a barrel portion 118b extending rearward from the flange portion 118a. The shaft member 117 is fixed to the end of the barrel portion 118b. The frame 103 includes a plate-like bearing member 103a, and the shaft member 117 is inserted through and supported by a shaft hole 103b. Since the accommodation unit 110 is rotatably supported not only by the support unit 120 but by the shaft member 117 and the bearing member 103a as well, wobbling of the rotation center PC of the accommodation unit 110 can be prevented for more stable rotation. Since the shaft member 117 and the bearing member 103a are located on the side of the accommodation unit 110 opposite to the opening 114a, the convenience of the insertion and removal operation of the container support units 24 by the user will not deteriorate.

The liquid agitation device 100 also includes a restriction unit 150 that restricts the movement of the accommodation member 111 in directions intersecting the rotation centerline CL. The restriction unit 150 of the present embodiment restricts the upward movement of the accommodation member 111 in the Z direction. During insertion and removal of the container support units 24, upward force may act on the front side of the accommodation unit 110. If the accommodation unit 110 is thereby tilted in orientation, a load in the bending direction acts on the shaft member 117. The provision of the restriction unit 150 can prevent such a change in orientation.

The restriction unit 150 of the present embodiment includes a plurality of contact portions 151 located above the rotation centerline CL and opposed to the circular cylindrical portion 112 in the Z direction. When the accommodation member 111 moves upward, the plurality of contact portions 151 abuts against the circular cylindrical portion 112 and physically prevents the movement. The plurality of contact portions 151 may be constantly in contact with the circular cylindrical portion 112, or located at a slightly separated position in the Z direction under normal conditions.

In the present embodiment, the restriction unit 150 includes two contact portions 151. The two contact portions 151 are located apart from each other in the circumferential direction of the circular cylindrical portion 112. The contact portions 151 of the present embodiment are rollers supported by bearings 152 about respective axes in a direction (Y direction) parallel to the rotation centerline CL. The bearings 152 are supported by the frame 102.

The two contact portions 151 are located at the same positions as the two contact portions 121 of the support unit 120 in the X and Y directions. Common parts can be used for the set of two contact portions 151 and bearings 152 and the set of two contact portions 121 and bearings 122 of the support unit 120. The use of common parts enables a reduction in parts types.

### Drive Unit

The structure of the drive unit 130 will be described with reference to FIGS. 19 and 20. The drive unit 130 is disposed outside (behind) the rear end portion 111b of the accommodation member 111 in the direction of the rotation centerline CL. Locating the drive unit 130 on the side of the accommodation unit 110 opposite to the opening 114a can reduce mechanisms lying near the opening 114a, and can improve the convenience of the insertion and removal operation of the container support units 24 by the user.

The drive unit 130 includes a motor 131 serving as a drive source. The motor 131 is fixed to a frame (not illustrated). A gear 132 is attached to the output shaft of the motor 131. In the present embodiment, the motor 131 is a stepping motor. The amount of rotation of the accommodation unit 110 can be controlled by the amount of rotation of the motor 131. The motor 131 may be a direct-current (DC) motor, in which case a rotation amount sensor such as a rotary encoder may be provided to control the amount of rotation.

The drive unit 130 includes gears 133, 134, and 135. The gears 133 and 134 are rotatably supported by a frame (not illustrated). The gears 133 and 134 are a two-stage gear each. The gear 132 meshes with the large gear of the gear 133, and the small gear of the gear 133 meshes with the large gear of the gear 134. The small gear of the gear 134 meshes with the gear 135. A torque limiter 133a capable of interrupting drive transmission is disposed between the small gear and large gear of the gear 133. The torque limiter 133a can prevent overload from acting on the motor 131. Moreover, if the user accidentally touches the accommodation unit 110 while the accommodation unit 110 is rotating, the torque limiter 133a can cut off the driving force to prevent high load from acting on the user's hand.

The gear 135 is fixed to the shaft member 117. When the motor 131 is driven, the driving force is transmitted to the shaft member 117 and rotates the accommodation unit 110. The bearing member 103a is located between the gear 135 and the shaft fixing member 118, whereby the accommodation unit 110 is positioned in the direction of the rotation centerline CL. In the present embodiment, the gear mechanism is used as the driving force transmission mechanism from the motor 131 to the shaft member 117. However, other types of transmission mechanisms such as a belt transmission mechanism may be used.

### Example of Agitation Operation

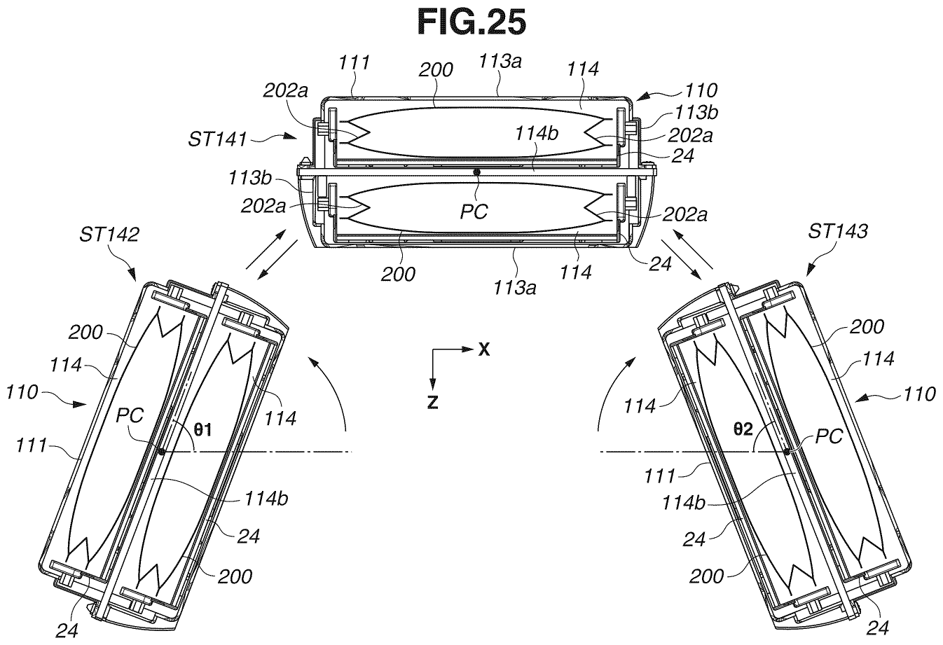

FIG. 25 illustrates an example of the agitation operation (rotation operation of the accommodation unit 110) by the driving of the drive unit 130. A state ST141 represents a state where the accommodation unit 110 is at the initial position. At the initial position, the accommodation member 111 is in a horizontal orientation with the long side portions 113a horizontal. The support portions 40 of the container support units 24 and the containers 200 in the accommodation spaces 114 are also horizontally oriented, and the gusset portions 202a at both sides of each container 200 are located at the same height.

A state ST142 represents a tilted state where the accommodation unit 110 is rotated by an angle θ1 counterclockwise from the initial position. The position of the accommodation unit 110 in such a state will be referred to as a left tilted position. The gusset portions 202a at both sides of each container 200 are situated so that the right gusset portion 202a is higher than the left gusset portion 202a in the drawing. The liquid in the container 200 flows from the side of the right gusset portion 202a to the side of the left gusset portion 202a.

A state ST143 represents a tilted state where the accommodation unit 110 is rotated by an angle θ2 clockwise from the initial position. The position of the accommodation unit 110 in such a state will be referred to as a right tilted position. The gusset portions 202a at both sides of each container 200 are situated so that the left gusset portion 202a is higher than the right gusset portion 202a in the drawing. The liquid in the container 200 flows from the side of the left gusset portion 202a to the side of the right gusset portion 202a.

The liquid in the containers 200 can be agitated by repeatedly changing the orientation of the accommodation unit 110 like the state ST141→the state ST142→the state ST141→the state ST143→the state ST141→ . . . .

In changing the orientation of the accommodation unit 110 from the state ST142 to the state ST143, the rotation may be temporarily stopped at the intermediate state ST141. Alternatively, the orientation of the accommodation unit 110 may be continuously changed from the state ST142 to the state ST143 without stopping the rotation at the intermediate state ST141. The same applies to the case of changing the orientation of the accommodation unit 110 from the state ST143 to the state ST142.

The orientation of the accommodation unit 110 may be continuously changed between the states ST142 and ST143 a plurality of times without stopping the rotation at the intermediate state ST141, and then the rotation may be stopped at the state ST141 for a predetermined time. Such an operation may be repeated. Stopping the rotation at the state ST141 for a predetermined time can reduce power consumption of the motor 131, while the uniformity of the liquid can be maintained by resuming the rotation before particle sedimentation in the liquid advances.

The angles θ1 and θ2 may be the same as each other or different from each other. The angles θ1 and θ2 may be set to the same angle in performing the agitation operation under certain conditions, and may be set to different angles in performing the agitation operation under different conditions. If the angles θ1 and θ2 are set to different angles, the relationship in magnitude may be alternated between θ1>θ2 and θ1<θ2.

Too small angles θ1 and θ2 may lower the agitation effect, and too large angles θ1 and θ2 may twist the containers 200. For such a reason, for example, the angles θ1 and θ2 may be angles selected from the range of 20 or greater and less than 90°, or angles selected from the range of 60° or greater and 80° or smaller. As a specific example, an angle of 70° can be cited.

The angles θ1 and θ2 may vary depending on the conditions under which the agitation operation is started. For example, greater angles may be used under conditions where sedimentation is estimated to have advanced. Smaller angles may be used under conditions where sedimentation is estimated to not have advanced. In other words, appropriate agitation based on the situation can be performed by setting larger angles when sedimentation has advanced more, and setting smaller angles when sedimentation has not advanced much. Note that the agitation effect also varies with the rotation speed and the orientation change pattern aside from the angles. Factors other than the angles can be changed for appropriate agitation.

The rotation control of the accommodation unit 110 involves acceleration from a stationary state, rotation at a constant speed, and deceleration to stop. Too high a constant rotation speed (rotation speed of the motor 131) can impose excessive load on the containers 200. Too low a constant rotation speed may use more time for agitation. For example, the constant rotation speed may be a speed selected from the range of 20 degrees per second (deg/sec) or higher and 160 deg/sec or lower, or a speed selected from the range of 30 deg/sec or higher and 140 deg/sec or lower. The constant rotation speed and the angles θ1 and θ2 may be associated with each other. For example, if the angles θ1 and θ2 are θα, the rotation speed may be set to V1. If the angles θ1 and θ2 are θβ that is greater than θα, the rotation speed may be set to V2 that is lower than V1. Such agitation operation control can reduce the load on the containers 200 and improve the fluidity of the liquid in a compatible manner.

### Rotation Range Regulating Structure

Excessive rotation of the accommodation unit 110 causes issues such as failure in the drive system and twisting of the liquid-dispensing tubes that obstructs liquid flow. Examples of possible causes of excessive rotation include the user accidentally rotating the accommodation unit 110 by hand during insertion and removal of the container support units 24 into/from the accommodation unit 110. The liquid agitation device 100 of the present embodiment includes a structure for physically regulating the rotation range of the accommodation unit 110.

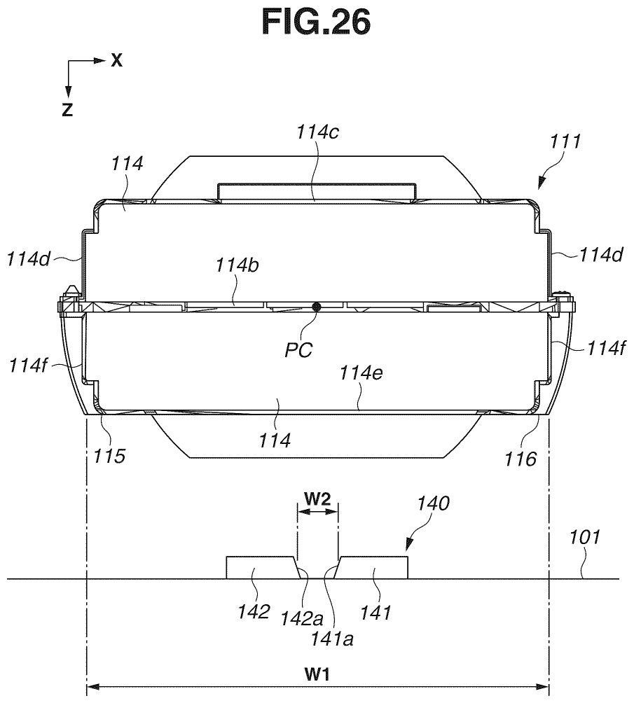

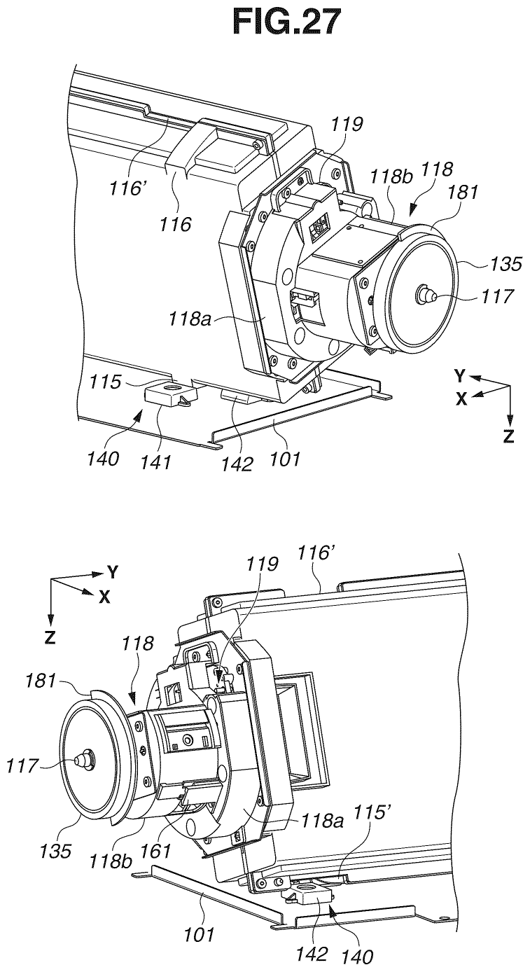

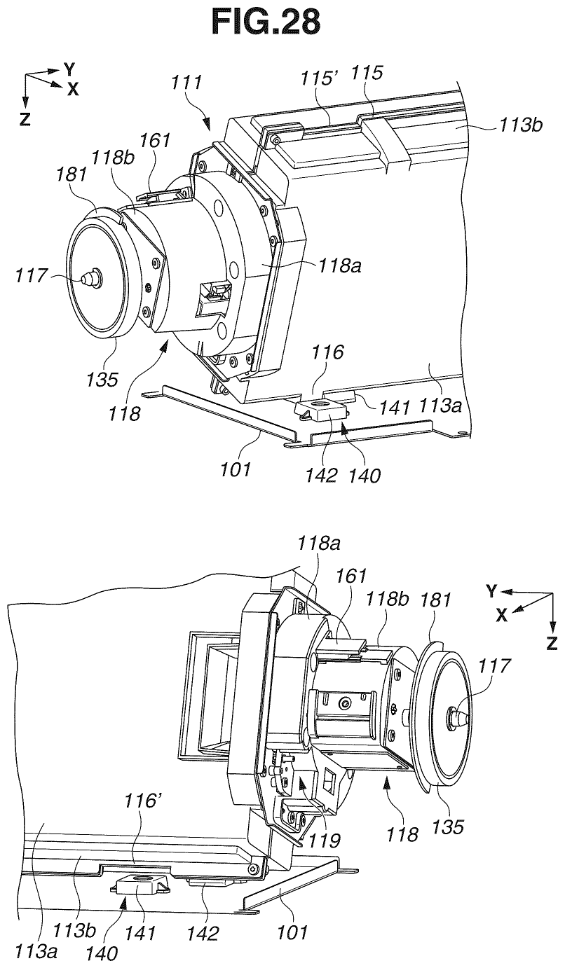

The rotation range regulating structure will be described with reference to FIGS. 19, 20, 23, and 26 to 28. FIG. 26 is an explanatory diagram illustrating a rotation regulation unit 140. FIGS. 27 and 28 are diagrams illustrating the mode of rotation regulation by the rotation regulation unit 140.

The liquid agitation device 100 includes the rotation regulation unit 140 that regulates the rotation range of the accommodation unit 110. The rotation regulation unit 140 includes stoppers 141 and 142 that make contact with the accommodation unit 110 to physically regulate the rotation of the accommodation unit 110. The rotation regulation unit 140 makes contact with the accommodation unit 110 and directly regulates the rotation of the accommodation unit 110, whereby excessive rotation of the accommodation unit 110 can be reliably prevented.

The stoppers 141 and 142 are block-shaped members fixed to the frame 101, and include sloped contact surfaces 141a and 142a. The stopper 141 defines the upper limit of the range of rotation of the accommodation unit 110 in one direction (rotation from the state ST141 to the state ST142 of FIG. 25) by abutting against a contact portion 115 formed on the outer wall portion 111c of the accommodation unit 110. The stopper 142 defines the upper limit of the range of rotation of the accommodation unit 110 in the other direction (rotation from the state ST141 to the state ST143 of FIG. 25) by abutting against a contact portion 116 formed on the outer wall portion 111c of the accommodation unit 110. In the present embodiment, the upper limit angles of the rotation range defined by the stoppers 141 and 142 are the same.

The contact portions 115 and 116 are formed on the rectangular cylindrical portion 113, not on the short side portions 113b but on a long side portion 113a in particular. If the contact portions 115 and 116 are configured to protrude from the short side portions 113b, the presence of the contact portions 115 and 116 tends to increase the diameter of the imaginary circle VC illustrated in FIG. 23. This increases the size of the liquid agitation device 100 in the X and Z directions. The formation of the contact portions 115 and 116 on part of the long side portion 113a enables miniaturization of the liquid agitation device 100.

As illustrated in FIG. 23, the contact surfaces 141a and 142a of the respective stoppers 141 and 142 are located inside the imaginary circle VC. In other words, the contact positions of the stoppers 141 and 142 with the contact portions 115 and 116 in the radial direction of rotation of the accommodation unit 110 (the radial direction of the imaginary circuit VC) fall within the imaginary circle VC. The positions of the stoppers 141 and 142 in the X and Z directions can thus be confined within a narrow area, and the liquid agitation device 100 can be miniaturized in the X and Z directions.

As illustrated in FIG. 26, when viewed in the direction of the rotation centerline CL, the contact portions 115 and 116 are separated by a distance W1 in the X direction and the stoppers 141 and 142 are separated by a distance W2 in the X direction in terms of the contact positions. The distances W1 and W2 have the relationship of W1>W2. Since the range where the stoppers 141 and 142 are disposed in the X direction falls within the width of the accommodation member 111, the liquid agitation device 100 can be miniaturized in the X direction.

The contact portions 115 and 116 are formed at the ends of the long side portion 113a in the X direction (at the borders with the short side portions 113b). Since the contact portions 115 and 116 are located relatively far from the rotation center PC, the rotation of the accommodation unit 110 can be more reliably regulated even if the stoppers 141 and 142 have relatively low rigidity.

The stoppers 141 and 142 are located apart in the direction of the rotation centerline CL (Y direction). The contact portions 115 and 116 are also located apart in the direction of the rotation centerline CL (Y direction), corresponding to the arrangement of the stoppers 141 and 142. Since the stoppers 141 and 142 are offset in the direction of the rotation centerline CL, the separation distance between the stoppers 141 and 142 can be reduced even with the rotatable range of the accommodation unit 110 being large. The liquid agitation device 100 can thus be miniaturized in the X direction.

FIG. 27 is a perspective view illustrating the state where the stopper 141 is in contact with the contact portion 115 to regulate the rotation of the accommodation unit 110, as seen in two directions. The contact of the contact portion 115 with the contact surface 141a of the stopper 141 physically restricts further rotation of the accommodation unit 110. The accommodation member 111 has an interference avoiding portion 115′ next to the contact portion 115. In the present embodiment, the interference avoiding portion 115′ is a recess, whereby the interference of the stopper 142 with the accommodation member 111 is avoided.

FIG. 28 is a perspective view illustrating the state where the stopper 142 is in contact with the contact portion 116 to regulate the rotation of the accommodation unit 110, as seen in two directions. The contact of the contact portion 116 with the contact surface 142a of the stopper 142 physically restricts further rotation of the accommodation unit 110. The accommodation member 111 has an interference avoiding portion 116′ next to the contact portion 116. In the present embodiment, the interference avoiding portion 116′ is a recess, whereby the interference of the stopper 141 with the accommodation member 111 is avoided.

In the present embodiment, the rotation range of the accommodation unit 110 is regulated by contact of the stoppers 141 and 142 with the accommodation member 111. However, the rotation range may be regulated using other portions. For example, the rotation range of the accommodation unit 110 may be regulated by contact of stoppers with the gear 133, 134, or 135 of the drive unit 130 for rotation restriction.

### Detection of Rotation Position

The accommodation unit 110 can be touched by the user, and the position of the accommodation unit 110 may be shifted when the power of the liquid agitation device 100 is off. Moreover, in the present embodiment, the provision of the torque limiter 133a in the drive transmission path of the drive unit 130 may cause an error between the rotation amount of the motor 131 and the rotation position of the accommodation unit 110. A large recognition error in the rotation position of the accommodation unit 110 can result in a failure of accurate rotation control of the accommodation unit 110 during the agitation operation. In the present embodiment, a sensor for detecting the position of the accommodation unit 110 is provided to improve the recognition accuracy of the accommodation unit 110.

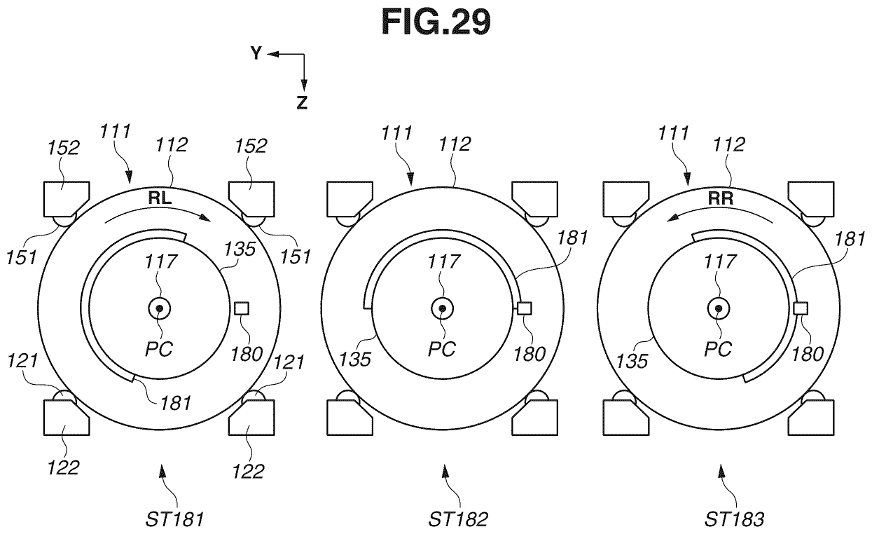

The detection of the rotation position will be described with reference to FIGS. 20, 27, 28, and 29. FIG. 29 is an explanatory diagram illustrating a position detection operation of the accommodation unit 110.

The accommodation unit 110 is equipped with a detection piece 181 that rotates about the rotation centerline CL along with the accommodation unit 110. In the present embodiment, the detection piece 181 is integrally formed on the gear 135, and fixed to the shaft member 117 using the gear 135. A sensor 180 for detecting the detection piece 181 is fixed to the frame 103. The sensor 180 is an optical sensor, for example, and detects whether the detection piece 181 lies at the detection position of the sensor 180. When the accommodation unit 110 is viewed from the rear, the detection position falls on 3 o'clock compared to a clock face centered on the rotation center PC (see FIG. 29).

The detection piece 181 includes a portion extended about the rotation centerline CL, and the sensor 180 detects the detection piece 181 when the rotation position of the accommodation unit 110 falls within a certain rotation range. In the present embodiment, the detection piece 181 has an arc shape (or sector shape) centered on the rotation center PC. In particular, in the present embodiment, the detection piece 181 has a semicircular arc shape.

In the present embodiment, the position where an edge of the detection piece 181 crosses the sensor 180 (the position where the detection result changes from non-detection to detection) is assumed as a reference position. The reference position corresponds to the initial position of the accommodation unit 110 (the state ST141 in FIG. 25). A state ST182 in FIG. 29 represents the positional relationship between the detection piece 181 and the sensor 180 when the accommodation unit 110 is at the initial position.

The detection piece 181 is disposed so that the detection piece 181 is detected by the sensor 180 while the accommodation unit 110 moves from the initial position to the left tilted position illustrated in the state ST142 of FIG. 25. A state ST183 of FIG. 29 illustrates an intermediate position during the rotation of the accommodation unit 110 from the initial position to the left tilted position (state ST142) of FIG. 25.

The detection piece 181 is disposed so that the detection piece 181 is not detected by the sensor 180 while the accommodation unit 110 moves from the initial position to the right tilted position illustrated in the state ST143 of FIG. 25. A state ST181 of FIG. 29 illustrates an intermediate position during the rotation of the accommodation unit 110 from the initial position to the right tilted position (state ST143) of FIG. 25.

An example of processing using the detection result of the sensor 180 will be described. This processing can be executed by a control unit 32 to be described below. Initially, an example of initialization processing for rotating the accommodation unit 110 to the initial position will be described with reference to FIG. 29. The initialization processing can be performed upon power-on of the liquid agitation device 100, for example. The initialization processing can also be performed on a regular basis after the power-on of the liquid agitation device 100, for example.

In the initialization processing, the control unit 32 initially acquires the detection result of the sensor 180 and determines whether the detection piece 181 is detected. If, as illustrated in the state ST181 of FIG. 29, the detection piece 181 is not detected, the accommodation unit 110 can be determined to be located at a position rotated toward the right tilted position (the state ST143 of FIG. 25) relative to the initial position. The control unit 32 thus rotates the accommodation unit 110 in the direction of the arrow RL using the drive unit 130, and stops rotating the accommodation unit 110 at the position where the detection result of the sensor 180 changes from non-detection to detection. Through such an operation, the accommodation unit 110 is brought into the initial position.

If the detection piece 181 is detected as illustrated in the state ST183 of FIG. 29, the accommodation unit 110 can be determined to be located at a position rotated toward the left tilted position (the state ST142 of FIG. 25) relative to the initial position. The control unit 32 thus rotates the accommodation unit 110 in the direction of the arrow RR using the drive unit 130. After the sensor 180 passes the position where the detection result of the sensor 180 changes from detection to non-detection, the control unit 32 reverses the rotation direction of the accommodation unit 110. The control unit 32 stops rotating the accommodation unit 110 at the position where the detection result of the sensor 180 changes from non-detection to detection. Through such an operation, the accommodation unit 110 is brought into the initial position.

In the present embodiment, the detection piece 181 is thus shaped to correspond to the rotation position of the accommodation unit 110. This enables determination of in which rotation direction the location of the accommodation unit 110 is rotated from the initial position, based on the detection result of the sensor 180. As a result, the initialization processing can be completed quickly.

Next, an example of rotation error processing of the accommodation unit 110 during the agitation operation will be described. In the agitation operation illustrated in FIG. 25, the detection result of the sensor 180 switches from non-detection to detection or from detection to non-detection each time the accommodation unit 110 passes the initial position (state ST141). If the detection result of the sensor 180 does not switch even when the rotation amount of the motor 131 reaches a predetermined amount, the control unit 32 can determine that a foreign object interferes with the drive unit 130 or the accommodation unit 110, making the accommodation unit 110 not rotatable.

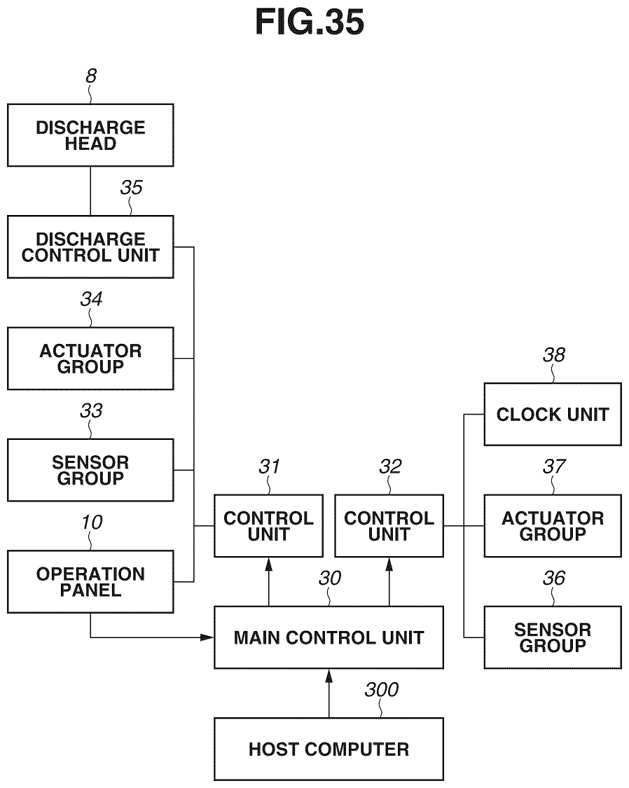

If the control unit 32 determines that the accommodation unit 110 is not rotatable, the control unit 32 can perform error processing such as stopping driving the motor 131 and notifying the user. For example, the control unit 32 displays a message to power off the liquid discharge apparatus 1 or the liquid agitation device 100 for initialization via the operation panel 10 or a host computer 300 (see FIG. 35), or issues the same message by voice, etc. Alternatively, the control unit 32 can guide the user to make a service call by displaying an error code via the operation panel 10 or the host computer 300, or issuing the same error code by voice, etc.

In the present embodiment, the detection piece 181 is integrally formed on the gear 135. However, the location of the detection piece 181 is not limited to the gear 135. For example, the detection piece 181 may be disposed on the accommodation member 111 or on the circular cylindrical portion 112.

### Liquid Dispensing Structure

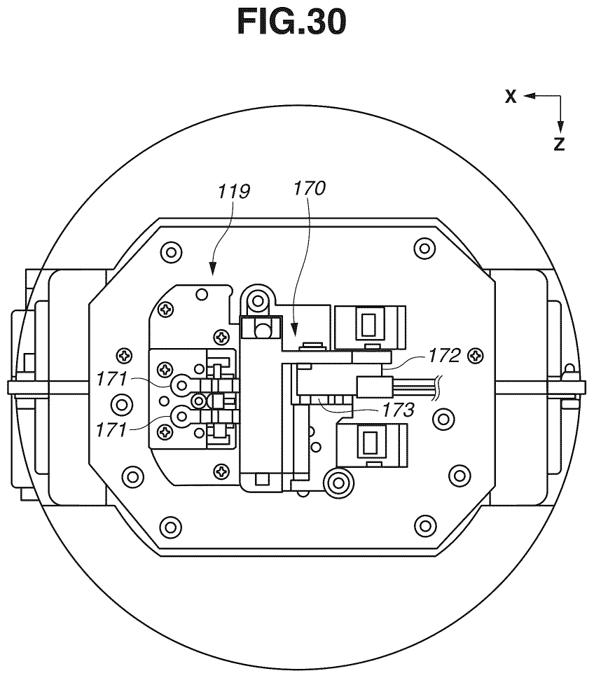

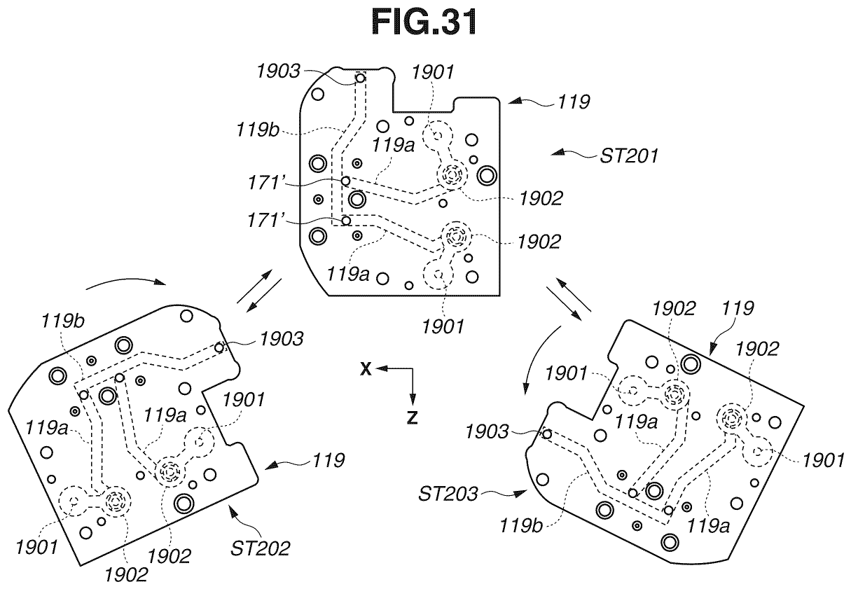

A structure for dispensing liquid from the container 200 via the needle member 110a will be described. A flow path forming member 119 is disposed on the rear end portion 111b of the accommodation member 111, between the rear end portion 111b and the shaft fixing member 118. FIG. 30 is a diagram illustrating the flow path forming member 119 on the rear end portion 111b of the accommodation member 111, as well as a valve unit 170, with the shaft fixing member 118 detached from the rear end portion 111b. FIG. 31 illustrates an example of flow paths formed by the flow path forming member 119 and changes in the orientation of the flow path forming member 119 due to rotation of the accommodation unit 110.

In FIG. 31, the flow path forming member 119 forms a liquid flow path 119b and two liquid flow paths 119a branching from the flow path 119b. An outlet port 1903 is formed at the end of the flow path 119b. Communication holes 1901 communicating with the needle members 110a of the upper and lower, two accommodation spaces 114 are formed at the ends of the respective flow paths 119a. Check valves 1902 are formed partway along the flow paths 119a. The liquid in each container 200 flows out of the accommodation unit 110 through the needle member 110a→the communication hole 1901→the flow path 119a→the flow path 119b→the outlet port 1903 in this order.

In FIG. 31, a state ST201 illustrates the orientation of the flow path forming member 119 when the accommodation unit 110 is at the initial position. A state ST202 illustrates the orientation of the flow path forming member 119 when the accommodation unit 110 is at the left tilted position (the state ST142 of FIG. 25). A state ST203 illustrates the orientation of the flow path forming member 119 when the accommodation unit 110 is at the right tilted position (the state ST143 of FIG. 25).

If the liquid agitation device 100 has not operated for a long time with the accommodation unit 110 at the initial state, particles contained in the liquid may sediment near the junctions between the flow path 119b and the two flow paths 119a. However, in the present embodiment, when the accommodation unit 110 is rotated by the agitation operation, the flow path forming member 119 also rotates and changes its orientation. Since the tilt of the flow paths 119a and 119b changes, the particles sedimented near the junctions flow with the liquid easily, whereby the flow paths 119a and 119b can be prevented from being clogged up with the particles.

The valve unit 170 illustrated in FIG. 30 is an electric valve that switches the flow paths 119a open and closed at positions 171′ near the respective junctions of the flow path 119b and the two flow paths 119a. The valve unit 170 includes two valve bodies 171 corresponding to the two positions 171′, a motor 172 that is a drive source, and a position sensor 173 that detects the positions of the two valve bodies 171. The motor 172 drives the valve bodies 171 via a cam mechanism (not illustrated) built in the valve unit 170, whereby the flow paths 119a are switched open and closed.

The valve unit 170 can select whether to close both the two flow paths 119a or open one of the flow paths 119a. For example, when containers 200 containing the same type of liquid are accommodated in the two accommodation spaces 114, the liquid is supplied from one of the containers 200 and the liquid supply from the other container 200 is stopped. When the one container 200 runs out of the liquid, the liquid is supplied from the other container 200 and the liquid supply from the one container 200 is stopped. The empty container 200 then can be replaced with a new container 200.

### Tube Routing Structure

A flexible tube is connected to the outlet port 1903, and the liquid is supplied to the liquid discharge apparatus 1 via the tube. As illustrated in FIG. 31, when the accommodation unit 110 rotates, the flow path forming member 119 also rotates and the position of the outlet port 1903 changes. The tube may be prevented from twisting because of the change in position, or behaving in an unintended manner, contacting the surrounding structures, and getting damaged. In the present embodiment, a structure (tube routing structure) for controlling the behavior of the tube due to the rotation of the accommodation unit 110 is employed to solve such issues.

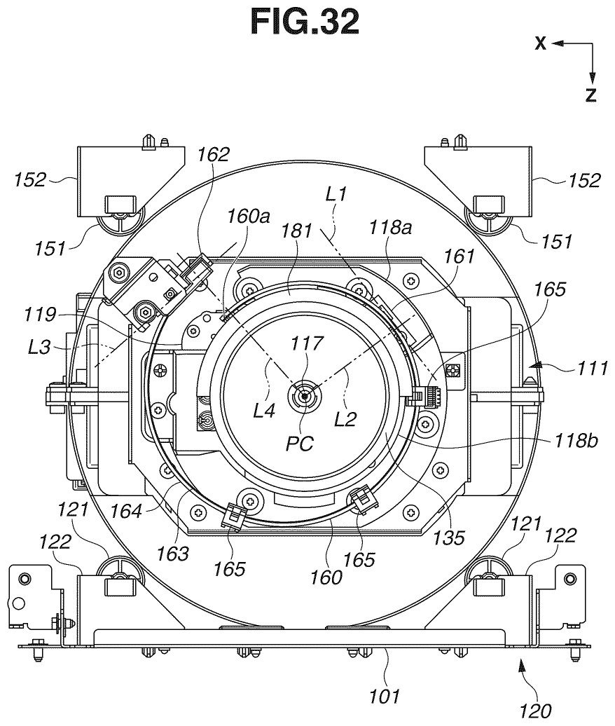

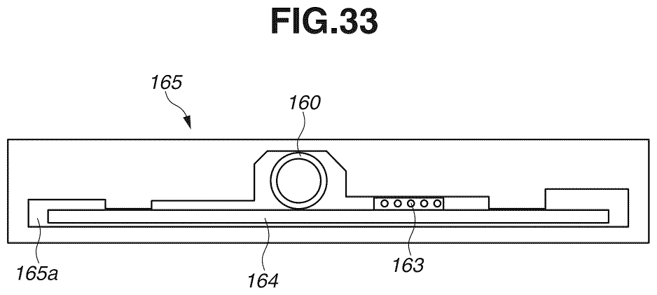

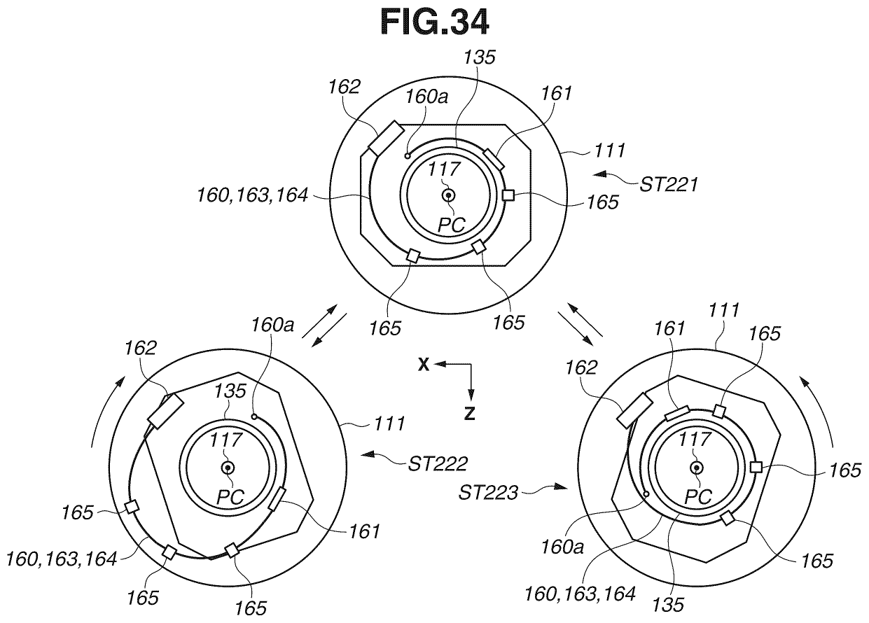

The tube routing structure will be described with reference to FIGS. 20, 24, 27, 28, and 32 to 34. FIG. 32 is a rear view of the rear part of the accommodation unit 110, illustrating a state where the drive unit 130 is detached except for the gear 135. FIG. 33 is an explanatory diagram illustrating a holding member 165. FIG. 34 is a diagram illustrating an example of changes in the shape of the tube 160 and the like during rotation of the accommodation unit 110.

The tube 160 is connected at an end 160a to the outlet port 1903 and extended from the accommodation unit 110. The tube 160 forms a dispensing flow path of the liquid dispensed from the accommodation unit 110 (i.e., the liquid from the containers 200). A fixing member 161 is disposed near the barrel portion 118b of the shaft fixing member 118. The fixing member 161 is a clip-like member that clamps an intermediate portion of the tube 160, and fixes the intermediate portion of the tube 160 to the accommodation unit 110. The fixing member 161 rotates with the accommodation unit 110 about the rotation centerline CL.

The frame 103 is equipped with a fixing member 162. The fixing member 162 is a clip-like member that fixes an intermediate portion of the tube 160 downstream of the fixing member 161 in the liquid flowing direction. The fixing member 162 is a stationary member that is fixed to the frame 103 and does not rotate with the accommodation unit 110. As illustrated in FIG. 20, the fixing members 161 and 162 are located on an imaginary plane VF orthogonal to the rotation centerline CL. While in the present embodiment the fixing members 161 and 162 are located on the common imaginary plane VF, an imaginary plane VF on which the fixing member 161 is located and an imaginary plane VF on which the fixing member 162 is located may be offset in the direction of the rotation centerline CL. In such a case, the tube 160 may be helically arranged to extend in the direction of the rotation centerline CL.

When the accommodation unit 110 is at the initial position, as illustrated in FIG. 32, the fixing member 161 falls on 2 o'clock and the fixing member 162 falls on 10 o'clock compared to a clock face centered on the rotation center PC. The tube 160 extends from the end 160a, passes over the barrel portion 118b clockwise, reaches the fixing member 161, and further passes below the barrel portion 118b clockwise to reach the fixing member 162. The tube 160 is extended further from the fixing member 162 (FIG. 24). FIGS. 32 and 33 illustrate the tube 160 within the section from the end 160a to the fixing member 162. As viewed in the Y direction, the fixing members 161 and 162 are located at least inside the circular cylindrical portion 112. This can reduce the size of the moving area of the tube 160 rotating with the accommodation unit 110 in the X direction.

The fixing member 161 fixes the intermediate portion of the tube 160 so that the tube 160 is oriented in a tangential direction L1 rather than a radial direction L2 of an imaginary circle on the X-Z plane, centered on the rotation center PC. In the present embodiment, this intermediate portion is oriented in the tangential direction L1. Similarly, the fixing member 162 fixes the intermediate portion of the tube 160 so that the tube 160 is oriented in a tangential direction L3 rather than a radial direction L4 of the imaginary circle on the X-Z plane, centered on the rotation center PC. In the present embodiment, this intermediate portion is oriented in the tangential direction L3. The tube 160 is thereby routed in an arc shape or spiral shape about the rotation centerline CL within the tube section from the end 160a of the tube 160 to the fixing member 161 and the tube section from the fixing member 161 to the fixing member 162. The fixing members 161 and 162 are configured to fix the tube 160 substantially in parallel with the tangential directions L1 and L3, respectively. This can guide the spreading direction of the tube 160 rotating with the rotation of the accommodation unit 110 to the gravitational direction, whereby the load acting on the tube 160 is reduced and the tube 160 can be prevented from breakage. Moreover, the spreading of the tube 160 in the X direction can thereby be reduced, and the routing space of the tube 160 can be miniaturized in the X direction.

In the present embodiment, the tube 160 is routed with an electrical cable (for example, flexible flat cable) 163 and a flexible strip member 164 within the tube section from the fixing member 161 and the fixing member 162.

The electrical cable 163 includes wiring of electrical parts included in the accommodation unit 110, such as the electrical wiring of the motor 172 and the sensor 173. Like the tube 160, the electrical cable 163 is fixed at an intermediate portion by the fixing member 161, and fixed at a downstream intermediate portion by the fixing member 162. In the cable section from the fixing member 161 to the fixing member 162, the electrical cable 163 is routed in an arc shape or spiral shape about the rotation centerline CL. The tube 160, the electrical cable 163, and the fixing members 161 and 162 are located on the rear end portion 111b-side of the accommodation member 111 rather than on the front end portion 111a-side. In particular, in the present embodiment, the tube 160, the electrical cable 163, and the fixing members 161 and 162 are located behind the rear end portion 111b. These components therefore do not interfere with the user's insertion and removal operation of the container support units 24 on the front end portion 111a-side, whereby the user's convenience can be improved.

The strip member 164 is a polyester film, for example. The strip member 164 supports the tube 160 and the electrical cable 163, and further stabilizes the behavior of the tube 160 and the electrical cable 163 during rotation of the accommodation unit 110. The strip member 164 is extended from the fixing member 161 to the fixing member 162.

To integrally route the tube 160 and the electrical cable 163 with the strip member 164, a plurality of holding members 165 for holding these components is used. The plurality of holding members 165 are binding members that are arranged within the section from the fixing member 161 to the fixing member 162 and integrally bundle the tube 160, the electrical cable 163, and the strip member 164. FIG. 33 is an explanatory diagram illustrating the structure of a holding member 165, which is configured to clamp intermediate portions of the tube 160, the electrical cable 163, and the strip member 164 in its gap 165a. The holding members 165 can prevent the tube 160, the electrical cable 163, and the strip member 164 from separating.

The behavior of the tube 160, the electrical cable 163, and the strip member 164 (hereinafter, referred to as the tube 160 and the like) during the rotation of the accommodation unit 110 will be described with reference to FIG. 34. A state ST221 represents a state where the accommodation unit 110 is at the initial position. The tube 160 and the like have an appropriate amount of play or slack within the space from the fixing member 161 to the fixing member 162.

A state ST222 illustrates the configuration of the tube 160 and the like when the accommodation unit 110 is at the left tilted position (the state ST142 of FIG. 25). In the state ST222, compared to the state ST221, the clockwise distance between the fixing members 161 and 162 in the drawing decreases and the two fixing members 161 and 162 approach each other. The amount of play or slack of the tube 160 and the like in the section from the fixing member 161 to the fixing member 162 increases, and the arc drawn by this section increases in radius.

A state ST223 illustrates the configuration of the tube 160 and the like when the accommodation unit 110 is at the right tilted position (the state ST143 of FIG. 25). In the state ST223, compared to the state ST221, the clockwise distance between the fixing members 161 and 162 in the drawing increases and the two fixing members 161 and 162 are separated. The amount of play or slack of the tube 160 and the like in the section from the fixing member 161 to the fixing member 162 decreases, and the arc drawn by this section decreases in radius. The tube 160 and the like come close to but do not contact the periphery of the barrel portion 118b, nor do the tube 160 and the like contact the valve unit 170.

As described above, the present embodiment employs the routing configuration in which the radius of the arc drawn by the tube 160 and the like changes depending on the direction of rotation of the accommodation unit 110. This enables control of the tube behavior associated with the rotation of the accommodation unit 110. As a result, the occurrence of twisting and unintended behavior of the tube 160 and the like can be prevented.

Like the foregoing mechanism for first agitation, an electric flow path valve is disposed on an intermediate portion of the tube 160. With such a configuration, the tube 160 can be closed and opened by closing and opening the flow path valve.

### Control Circuit

A configuration of a control circuit of the system A will be described with reference to FIG. 35. FIG. 35 is a block diagram of the control circuit of the system A. A main control unit 30 controls the entire system A based on instructions from the host computer 300 and the operation panel 10. A control unit 31 controls the liquid discharge apparatus 1 based on instructions from the main control unit 30. The control unit 32 controls the liquid storage apparatuses 20A and 20B based on instructions from the main control unit 30. For example, the main control unit 30 and the control units 31 and 32 each include at least one processor, at least one storage device, and at least one input/output interface. Examples of the storage device include semiconductor memories such as a random access memory (RAM) and a read-only memory (ROM). The input/output interface performs signal input and output between the processor and external devices (such as sensors and motors).

A discharge control unit 35 controls the discharge head 8, and performs liquid discharge control in particular. An actuator group 34 includes a conveyance motor that is the drive source of the conveyance unit 6, a carriage motor that is the drive source of a moving mechanism of a carriage (not illustrated), a take-up motor that is the drive source of the take-up unit 5, and a recovery motor that is the drive source of the recovery unit 9. The actuator group 34 further includes a cutter motor that is the drive source of a cutter (not illustrated) for cutting the recording medium M after image recording. A sensor group 33 includes various sensors included in the liquid discharge apparatus 1.

A clock unit 38 is a counter that outputs the count result of elapsed time to the control unit 32. In the case of managing the liquid agitation period by time, the count result of the clock unit 38 can be used. The count result of the clock unit 38 can also be used to determine agitation timing.

An actuator group 37 includes the motor 635 included in the pressing unit 600 that is the mechanism for first agitation, the motors 131 and 172 included in the liquid agitation device 100 that is the mechanism for second agitation, and the flow path valves 52. A sensor group 36 includes a sensor 23C to be described below, the sensor 58, the remaining level detection sensor 230A, and the sensors 26 and 180 included in the liquid agitation device 100.

### Processing Example of Control Circuit

An example of processing that the control unit 32 executes regarding the agitation operation of the liquid agitation device 100 will be described. Here, an agitation operation using the rotation regulation unit 140 will be described. As described above, the rotation regulation unit 140 is a structure that physically regulates the rotation range of the accommodation unit 110. At the same time, the rotation regulation unit 140 can apply impact to the accommodation unit 110 for enhanced liquid agitation effect by deliberately causing the contact portions 115 and 116 to collide with the stoppers 141 and 142. However, the contact of the contact portions 115 and 116 with the stoppers 141 and 142 can cause striking noise. In view of this, operating conditions are determined in advance, and one of the following rotation operations with different rotation ranges of the accommodation unit 110 is performed depending on whether the contact conditions hold.

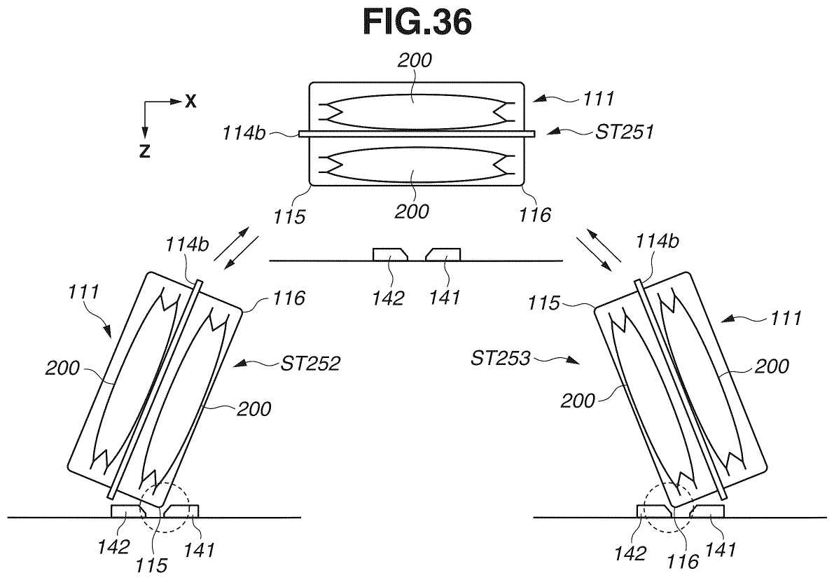

FIG. 36 illustrates an example of the rotation operation of the accommodation unit 110 for producing a normal agitation action. A state ST251 represents a state where the accommodation unit 110 is at the initial position.

A state ST252 represents a state where the accommodation unit 110 is rotated to the left tilted position. Here, the control unit 32 reverses the rotation direction of the accommodation unit 110 before the contact portion 115 contacts the stopper 141. For example, the control unit 32 controls the rotation amount of the motor 131 so that the rotation of the accommodation unit 110 stops before the contact portion 115 comes into contact with the stopper 141, and then reverses the motor 131. This can prevent the occurrence of striking noise since the contact portion 115 does not contact the stopper 141.

A state ST253 represents a state where the accommodation unit 110 is rotated to the right tilted position.

The control unit 32 similarly reverses the rotation direction of the accommodation unit 110 before the contact portion 116 contacts the stopper 142. For example, the control unit 32 controls the rotation amount of the motor 131 so that the rotation of the accommodation unit 110 stops before the contact portion 116 comes into contact with the stopper 142, and then reverses the motor 131. This can prevent the occurrence of striking noise since the contact portion 116 does not contact the stopper 142.

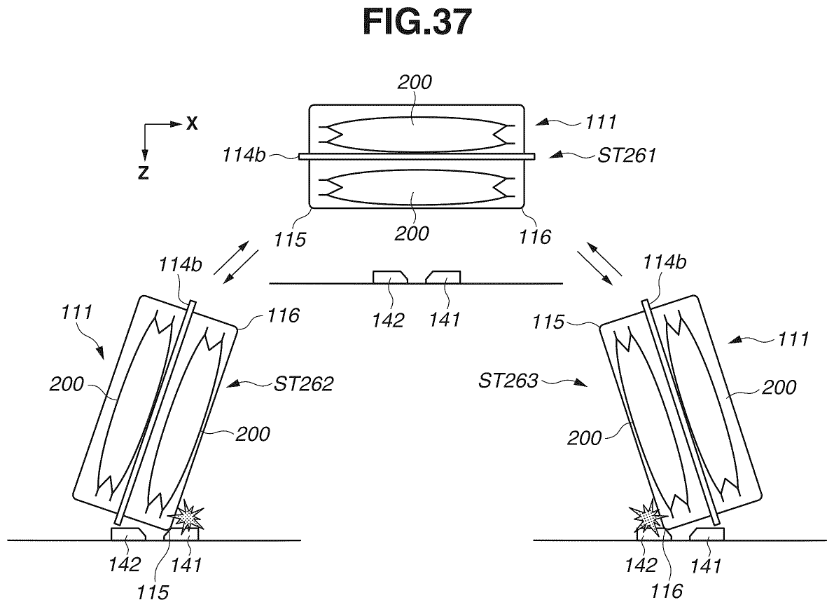

FIG. 37 illustrates an example of the rotation operation of the accommodation unit 110 for producing a high agitation action. This rotation operation is triggered by events such as when the system A is powered on, when the liquid agitation device 100 is powered on, when the containers 200 are replaced, and when containers 200 left standing for a long period of time are used.

A state ST261 represents the state where the accommodation unit 110 is at the initial position. A state ST262 represents a state where the accommodation unit 110 is rotated to the left tiled position. Here, the control unit 32 reverses the rotation direction of the accommodation unit 110 after the contact portion 115 contacts the stopper 141. For example, the control unit 32 controls the rotation amount of the motor 131 so that the rotation of the accommodation unit 110 continues until the contact portion 115 comes into contact with the stopper 141, and then stops and reverses the motor 131. The contact of the contact portion 115 with the stopper 141 applies impact to the accommodation unit 110, whereby the agitation performance of the liquid in the containers 200 improves. The impact acting on the accommodation unit 110 can be prevented from affecting the drive system, since the torque limiter 133a interrupts the transmission of the impact to the motor 131.

A state ST263 represents a state where the accommodation unit 110 is rotated to the right tilted position.

The control unit 32 similarly reverses the rotation direction of the accommodation unit 110 after the contact portion 116 contacts the stopper 142. For example, the control unit 32 controls the rotation amount of the motor 131 so that the rotation of the accommodation unit 110 continues until the contact portion 116 comes into contact with the stopper 142, and then stops and reverses the motor 131. The contact of the contact portion 116 with the stopper 142 applies impact to the accommodation unit 110, whereby the agitation performance of the liquid in the containers 200 improves.

In the rotation operation of FIG. 37, the control unit 32 may control the application of impact only at one of the tilted positions. Specifically, at the left tilted position, the control unit 32 reverses the rotation direction of the accommodation unit 110 after the contact portion 115 comes into contact with the stopper 141. At the right tilted position, the control unit 32 reverses the rotation direction of the accommodation unit 110 before the contact portion 116 comes into contact with the stopper 142, so that the contact portion 116 will not contact the stopper 142.

As an opposite scenario, at the right tilted position, the control unit 32 reverses the rotation direction of the accommodation unit 110 after the contact portion 116 comes into contact with the stopper 142. At the left tilted position, the control unit 32 reverses the rotation direction of the accommodation unit 110 before the contact portion 115 comes into contact with the stopper 141, so that the contact portion 115 will not contact the stopper 141.

When thus controlling the application of impact only at one of the tilted positions, the control unit 32 may change the combination of the contact portion and stopper to collide under predetermined conditions. For example, when the rotation operation that causes collision between the contact portion 115 and the stopper 141 is performed a predetermined number of times, the combination of the contact portion and stopper to collide is switched to the contact portion 116 and the stopper 142. When the rotation operation that causes collision between the contact portion 116 and the stopper 142 is performed a predetermined number of times, the combination of the contact portion and stopper to collide is switched to the contact portion 115 and the stopper 141 again. The conditions to switch the combinations may be the time or period of the rotation operation aside from the number of times of the rotation operation.

In the present embodiment, the first agitation for ink with not particularly high colorant sedimentation velocity is described to agitate the ink through the motion of deforming the containers 200. On the other hand, the second agitation for ink with high colorant sedimentation velocity is described to agitate the ink through a large motion of changing the orientation of the containers 200 to turn over the ink vertically.

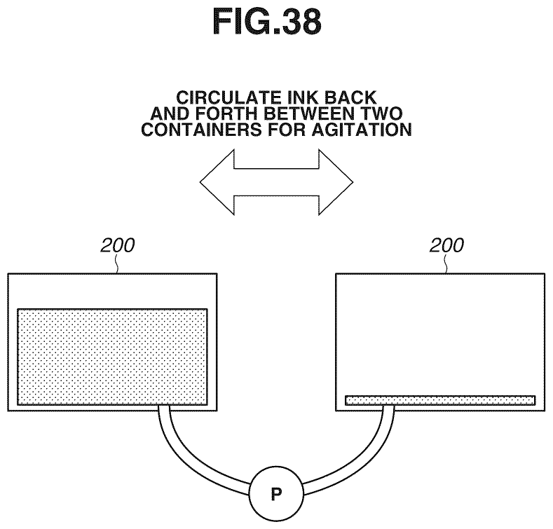

However, the present disclosure is not limited to these methods. For example, as illustrated in FIG. 38, two containers 200 may be connected by a tube, and agitation may be performed by circulating the ink back and forth using a pump P in both the first agitation and the second agitation.

In the present embodiment, the first agitation and the second agitation are used depending on the colorant sedimentation velocity. However, inks may contain particle components such as resin particles in addition to pigments. In such a case, recording may be affected by the sedimentation of other particle components rather than the pigments that are colorants. The first agitation and the second agitation may therefore be used based not on the colorants but on particle components with the highest sedimentation velocity in the inks.

### Liquid Agitation and Valve Opening-Closing Control

The liquid agitation operation and the valve opening-closing performed by the pressing unit 600 and the liquid agitation device 100 according to the present embodiment will now be described.

The liquid agitation operation is performed in cases such as when liquid is filled into the discharge head 8, when the count result of the clock unit 38 exceeds a predetermined time, and when the user instructs so. In particular, liquid agitation may be used during recording on the recording medium M.

Examples of such situations include where there are two containers 200 (packs) for each color as in the present embodiment and one of the containers 200 is running low in remaining liquid and may switch to the other but the other container 200 has not been agitated for a predetermined time. Another example is where the containers 200 are agitated after a lapse of a predetermined time from the end of the previous agitation operation, and the liquid discharge apparatus 1 is performing a recording operation when the predetermined time elapses. Moreover, the liquid discharge apparatus 1 may perform a recording operation during agitation of the containers 200. In such situations, liquid discharge may be affected if the pressure from the ink flow produced by the agitation operation propagates through the tubes 51 (160) to the discharge head 8 and fluctuates the internal pressure of the discharge head 8. In particular, in the present embodiment, agitation during recording is performed under stronger agitation conditions (second agitation conditions) than normal agitation conditions (first agitation conditions) so that the agitation operation is completed in a short time. The discharge is thus significantly affected by pressure fluctuations.

In the present embodiment, when the agitation operation is performed in parallel with a recording operation, the electric flow path valves 52 disposed partway along the tubes 51 (160), which are the flow paths connecting the containers 200 undergoing the agitation operation and the discharge head 8, are therefore closed to close off the flow paths. This can prevent the pressure fluctuations due to the agitation operation from propagating up to the interior of the discharge head 8. By contrast, when the agitation operation is performed without a recording operation, the foregoing flow path valves 52 are opened to open up the flow paths. The reason is that when no recording operation is performed, the propagation of pressure fluctuations to the interior of the discharge head 8 does not have much effect since discharge is not being performed. In addition, the time from the reception of signals to start a recording operation to the supply of the liquids to the interior of the discharge head 8 can be reduced.

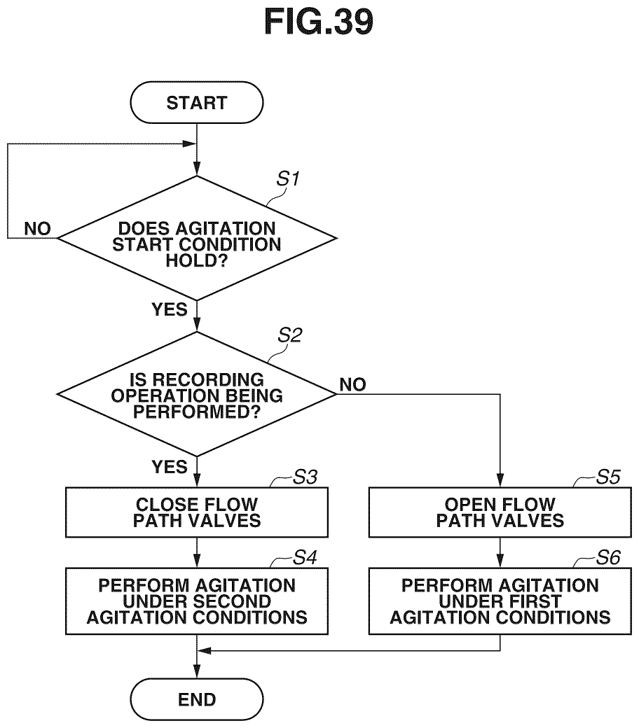

Next, a procedure for the opening and closing of the flow path valves 52 in performing the agitation operation will be described with reference to FIG. 39. In step S1, the control unit 32 checks whether an agitation start condition holds. Examples of the agitation start condition here include that a predetermined time has elapsed since the previous agitation of the containers 200, that a container 200 is attached to the liquid storage apparatus 20A or 20B, and that the user inputs agitation instructions. If, in step S1, the control unit 32 determines that the agitation start condition does not hold (NO in step S1), the processing returns to step S1. Step S1 is repeated until the agitation start condition holds. On the other hand, if the control unit 32 determines that the agitation start condition holds (YES in step S1), the processing proceeds to step S2.

In step S2, the control unit 32 determines whether the liquid discharge apparatus 1 is performing a recording operation. As employed herein, performing a recording operation also includes cases where liquid is not currently being discharged but scheduled to be discharged during the agitation operation. If the control unit 32 determines that a recording operation is being performed (YES in step S2), the processing proceeds to step S3. In step S3, the control unit 32 closes the flow path valves 52 of the flow paths connected to the containers 200 on which the agitation operation is to be performed. In step S4, the control unit 32 performs agitation under the second agitation conditions.

On the other hand, if, in step S2, the control unit 32 determines that a recording operation is not being performed (NO in step S2), the processing proceeds to step S5. In step S5, the control unit 32 opens the flow path valves 52 of the flow paths connected to the containers 200 on which the agitation operation is to be performed. In step S6, the control unit 32 performs agitation under the first agitation conditions.

The agitation conditions can be modified as appropriate. In the present embodiment, the second agitation conditions provide higher agitation efficiency than the first agitation conditions, and the duration of the second agitation conditions is shorter than that of the first agitation conditions.

Reducing the duration of the second agitation conditions can save power for other operations during the recording operation.

In the case of the mechanism for first agitation, the agitation conditions can be modified, for example, by changing at least one of the pressing cycle, the number of times of pressing, pressing speed, pressing location, and the duration of the pressing operation included in the second agitation conditions compared to the first agitation conditions. In the case of the mechanism for second agitation, the agitation conditions can be modified, for example, by changing at least one of the rotation cycle, the number of rotations, the rotation angle, the rotation pattern, and the duration of the rotation operation included in the second agitation conditions compared to the first agitation condition.

Specifically, in the case of the mechanism for first agitation, the agitation efficiency can be improved by making the pressing cycle in the second agitation conditions longer than in the first agitation conditions. The agitation efficiency can also be improved by increasing the number of times of pressing or by bringing the pressing location closer to where the bag 202 bulges. Furthermore, the agitation efficiency can be improved by repeating the pressing operation and the pressure relief operation with a temporal interval between the pressure relief operation and the next pressing operation as described above. Increasing the speed of the pressing operation enhances the fluidity of the liquid and decreasing the speed of the pressure relief operation ensures particle movement, whereby the agitation effect can be improved.

In the case of the mechanism for second agitation, the agitation efficiency can be improved by increasing the rotation angles θ1 and θ2, increasing the number of rotations, increasing the rotation speed upon collision with the stoppers 141 and 142, etc. Changing the rotation pattern to promote liquid agitation, such as performing rotation once, pausing for a predetermined time, and then resuming rotation, can also improve the agitation efficiency.

In view of power consumption, the second agitation conditions may be configured to have agitation efficiency equal to or lower than that of the first agitation conditions. In such a case, if the recording operation ends during agitation, the subsequent agitation may be performed by switching to other agitation conditions (third agitation conditions) with higher agitation efficiency than that of the second agitation conditions.

If there is time to spare during the recording operation, the first agitation conditions and the second agitation conditions may be made the same as each other.

In the present embodiment, a recording operation may be started by user instructions or the like while the agitation operation is being performed. In such a case, the agitation operation may be suspended, and then resumed after the recording operation ends. Alternatively, the recording operation may be performed while continuing the agitation operation without suspension.

The present embodiment can be applied to both the mechanism for first agitation and the mechanism for second agitation. Unlike the mechanism for first agitation, the liquid agitation device 100 that is the mechanism for second agitation agitates liquid by rotating the containers 200. Pressure fluctuations propagating to the discharge head 8 thus have little or no effect on the image quality even with the tube 160 open. The valve unit 170 may therefore be opened in step S3, or the valve unit 170 does not need to be provided in the first place.

As described above, in performing an agitation operation, appropriate agitation can be performed by changing the valve opening-closing and agitation conditions depending on whether the recording operation is performed in parallel. In particular, the foregoing configuration can prevent pressure fluctuations due to the agitation operation from propagating to the discharge head 8 and affecting the image quality even when the agitation operation is performed in parallel with the recording operation.

### Second Embodiment

The present embodiment differs from the first embodiment in valve opening-closing control, but otherwise is similar to the first embodiment. The differences will hereinafter be described in detail.

In the present embodiment, valves are closed even when recording operations are not performed. Such a configuration enables immediate response when a recording operation is suddenly performed during the agitation operation, without waiting for the end of the agitation operation or the closing of the valves.

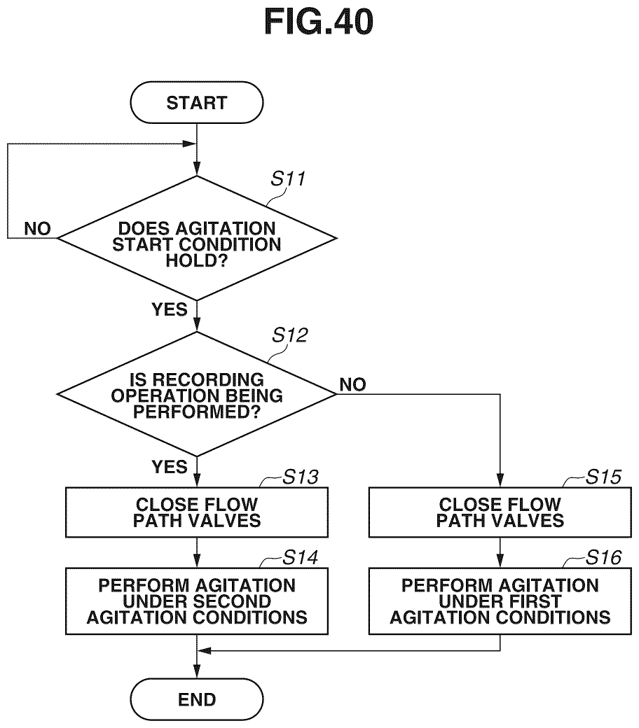

FIG. 40 is a flowchart related to the opening and closing of flow path valves in performing the agitation operation according to the present embodiment. Steps S11 to S14 and S16 are similar to steps S1 to S4 and S6, respectively. A description thereof will thus be omitted. If, in step S12, the control unit 32 determines that the liquid discharge apparatus 1 is not performing a recording operation (NO in step S12), the processing proceeds to step S15. In step S15, the control unit 32 closes the flow path valves 52 connected to the containers 200 on which the agitation operation is to be performed. The processing proceeds to step S16.

As described above, even in the present embodiment, appropriate agitation can be performed in performing a recording operation, by changing the valve opening-closing and agitation conditions depending on whether the recording operation is performed in parallel. In particular, the configuration described above enables immediate response when a recording operation is suddenly performed, since the flow path valves 52 are closed even when the agitation is performed other than during recording operations.

### Third Embodiment

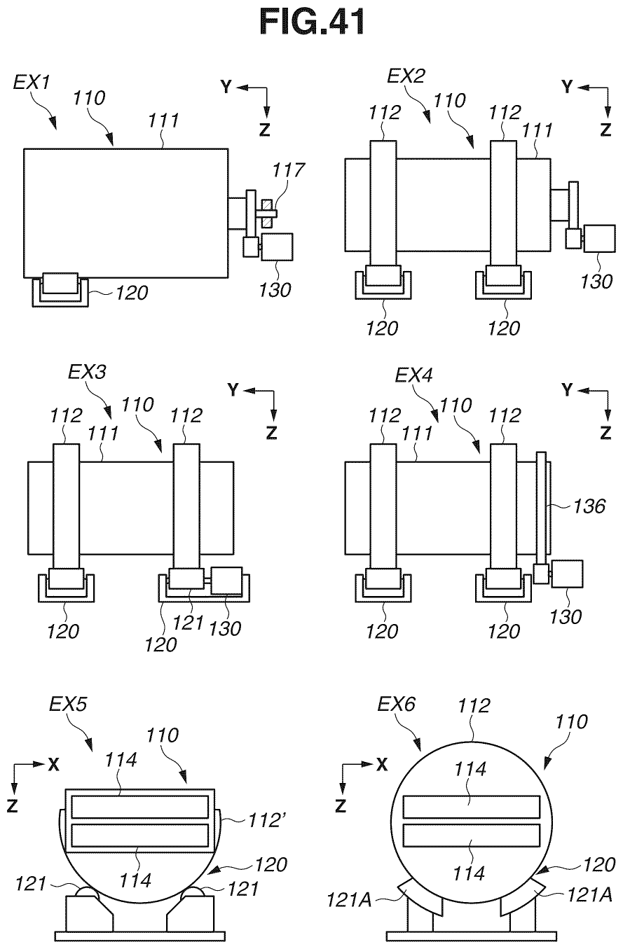

Other configuration examples of the liquid agitation device 100 will be described with reference to FIGS. 41 to 43.

The outer wall portion 111c of the accommodation member 111 according to the first and second embodiments includes the circular cylindrical portion 112 and the rectangular cylindrical portion 113. However, as in configuration example EX1 of FIG. 41, the entire outer wall portion of the accommodation member 111 may have a circular cylindrical shape.

In the first and second embodiments, the support unit 120, which is a shaftless support structure, and the shafted support structure (shaft member 117 and bearing member 103a) are described to be combined as the rotation support structure of the accommodation unit 110. However, the accommodation unit 110 may be rotatably supported by shaftless support structures alone. Configuration example EX2 of FIG. 41 is one example thereof, where the accommodation unit 110 is supported by two sets of circular cylindrical portions 112 and support units 120 that are located apart in the direction of the rotation centerline CL. This can eliminate the need for the shaft member 117 and the bearing member 103a.

In a configuration where the accommodation unit 110 is rotatably supported using only shaftless support structures as in this example, the drive unit 130 may be configured to rotate the accommodation unit 110 by rotating contact portions 121 (rollers) as in configuration example EX3 of FIG. 41. Alternatively, as in configuration example EX4 of FIG. 41, the drive unit 130 may be configured to include a gear 136 fixed to the periphery of the accommodation member 111 and rotate the accommodation unit 110 by transmitting driving force to the gear 136.

In the first and second embodiments, the circular cylindrical portion 112 is provided over the entire circumference of the accommodation member 111, and the circular cylindrical portion 112 is supported by the support unit 120. However, the portion for the support unit 120 to contact may only cover the rotation range of the accommodation unit 110. For example, as in configuration example EX5 of FIG. 41, an arcuate portion 112′ may be provided instead of the circular cylindrical portion 112, and the contact portions 121 of the support unit 120 may be configured to contact the peripheral surface of the arcuate portion 112′.

In the first and second embodiments, the contact portions 121 of the support unit 120 are configured as rollers. However, the contact portions 121 may be members that make sliding contact with the accommodation member 111 instead of rolling members like the rollers. Configuration example EX6 of FIG. 41 is one example thereof. Contact portions 121A that replace the contact portions 121 are members having a curved surface with which the circular cylindrical portion 112 makes sliding contact, and do not rotate.

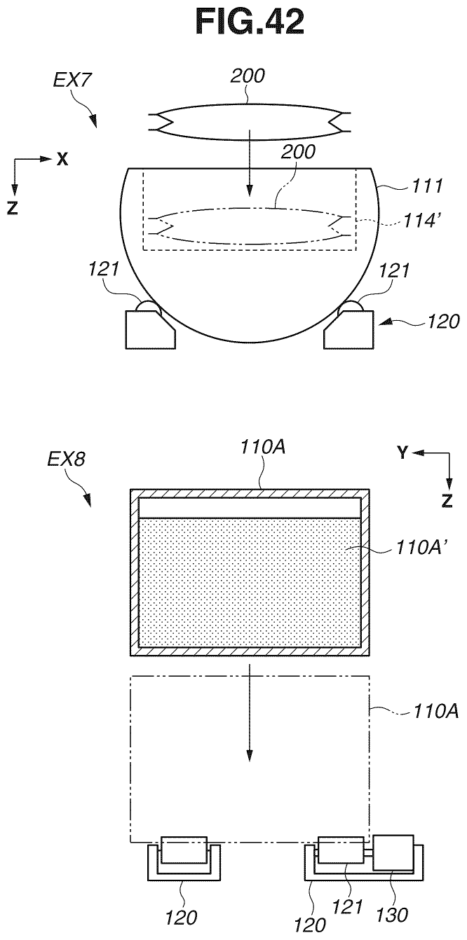

The first and second embodiments are configured so that the opening 114a of the accommodation spaces 114 is formed in the front end portion 111a of the accommodation member 111 in the direction of the rotation centerline CL. However, the opening may open in a direction intersecting the rotation centerline CL. For example, configuration example EX7 of FIG. 42 is a configuration where an accommodation space 114′ that replaces the accommodation spaces 114 opens upward. The containers 200 (or containers 200 and container support units 24) are vertically inserted into and removed from the accommodation space 114′.

In the first and second embodiments, the accommodation unit 110 is configured so that the containers 200 are replaceable. However, the accommodation unit 110 may be a liquid tank equivalent to a container 200. Configuration example EX8 of FIG. 42 is one example thereof, where an accommodation unit 110A itself constitutes a liquid tank. In this configuration example EX8, like configuration example EX3 of FIG. 41, the accommodation unit 110A is rotatably supported using the shaftless support units 120 alone. When the liquid runs out, the accommodation unit 110A is thus replaced as a unit.

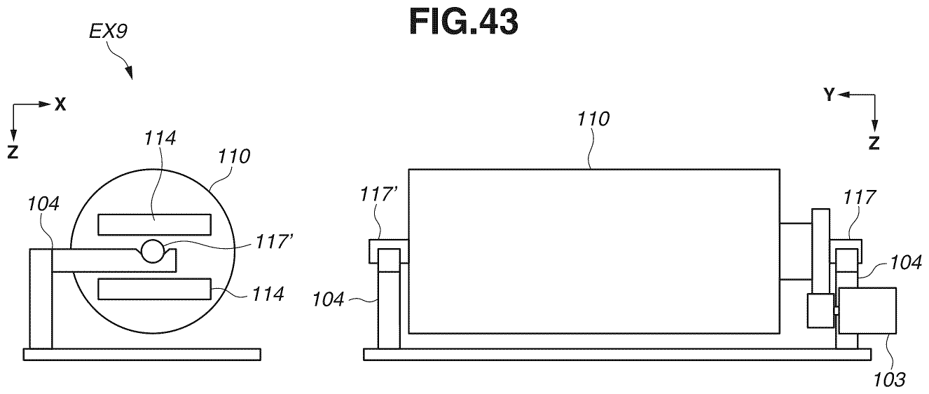

In the first and second embodiments, the support unit 120, which is a shaftless support structure, and the shafted support structure (shaft member 117 and bearing member 103a) are described to be combined as the rotation support structure of the accommodation unit 110. However, the accommodation unit 110 may be rotatably supported using shafted support structures alone. Configuration example EX9 of FIG. 43 is one example thereof. The accommodation unit 110 includes not only the shaft member 117 at the rear end but also a shaft member 117′ at the front end, which are pivotally supported by respective bearings 104. The bearings 104 are configured to support the shaft members 117 and 117′ with their horizontally extending beam portions. The shaft member 117′ and the corresponding beam portion are configured to come between the two accommodation spaces 114 when the accommodation unit 110 is at the initial position, so that the insertion and removal of the container support units 24 into/from the accommodation spaces 114 are not significantly obstructed.

Even with the foregoing agitation mechanisms, similar effects can be obtained by controlling the valves depending on recording operations as in the first and second embodiments.

### Other Embodiments

The present disclosure can also be implemented by processing for supplying a program for implementing one or more functions of the foregoing embodiments to a system or an apparatus via a network or a storage medium, and reading and executing the program by one or more processors in a computer of the system or apparatus. Circuits for implementing one or more functions (such as an application-specific integrated circuit [ASIC]) can also be used for implementation.

According to an aspect of the present disclosure, a recording apparatus and a control method that can perform agitation while preventing adverse effects on image quality can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-188690, filed Oct. 28, 2024, which is hereby incorporated by reference herein in its entirety.

What is claimed is:

1. A recording apparatus comprising:
a discharge head configured to discharge liquid;
a liquid container configured to accommodate the liquid to be supplied to the discharge head;
a flow path configured to connect the discharge head and the liquid container;
a valve configured to open and close the flow path; and
an agitation unit configured to agitate the liquid in the liquid container,
wherein, in a case where the agitation unit performs agitation during a recording operation, the valve is closed.

2. The recording apparatus according to claim 1, wherein the recording operation includes discharging the liquid from the discharge head.

3. The recording apparatus according to claim 1, wherein, in a case where the agitation unit performs the agitation other than during the recording operation, the valve is open.

4. The recording apparatus according to claim 1, wherein, in a case where the agitation unit performs the agitation other than during the recording operation, the valve is closed.

5. The recording apparatus according to claim 1, wherein the agitation unit is configured to change an agitation condition.

6. The recording apparatus according to claim 5, wherein a duration in which the agitation unit performs the agitation during the recording operation is shorter than a duration in which the agitation unit performs the agitation other than during the recording operation.

7. The recording apparatus according to claim 5, wherein an agitation efficiency in a case where the agitation unit performs the agitation during the recording operation is higher than an agitation efficiency in a case where the agitation unit performs the agitation other than during the recording operation.

8. The recording apparatus according to claim 1,
wherein the liquid container has flexibility,
wherein the agitation unit includes a pressing unit, and
wherein the pressing unit is configured to agitate the liquid by repeatedly performing a pressing operation and a pressure relief operation on the liquid container.

9. The recording apparatus according to claim 1,
wherein the agitation unit includes a drive unit configured to rotate the liquid container, and
wherein the drive unit is configured to agitate the liquid by rotating the liquid container.

10. The recording apparatus according to claim 1,
wherein the liquid container includes a first liquid container and a second liquid container, and
wherein a first valve and a second value are disposed on a flow path connecting the discharge head and the first liquid container and on a flow path connecting the discharge head and the second liquid container, respectively.

11. The recording apparatus according to claim 10,
wherein the first liquid container has flexibility,
wherein an agitation unit for the first liquid container is a pressing unit,
wherein the pressing unit is configured to agitate liquid in the first liquid container by repeatedly performing a pressing operation and a pressure relief operation on the liquid container,
wherein an agitation unit for the second liquid container is a drive unit configured to rotate the second liquid container, and
wherein the drive unit is configured to agitate the liquid by rotating the second liquid container.

12. The recording apparatus according to claim 11,
wherein, in a case where the agitation unit for the first liquid container performs agitation during the recording operation, the first valve is closed, and
wherein, in a case where the agitation unit for the second liquid container performs agitation during the recording operation, the second value is open.

13. The recording apparatus according to claim 10, wherein a first liquid accommodated in the first liquid container and a second liquid accommodated in the second liquid container are pigment-containing inks.

14. The recording apparatus according to claim 13, wherein the pigment in the second liquid sediments more easily than the pigment in the first liquid.

15. The recording apparatus according to claim 13, wherein the second liquid is white ink.

16. The recording apparatus according to claim 15, wherein the white ink contains titanium oxide.

17. The recording apparatus according to claim 13, wherein the second liquid is a metal powder-containing liquid.

18. A method for controlling a recording apparatus including a discharge head configured to discharge liquid, a liquid container configured to accommodate the liquid to be supplied to the discharge head, a flow path configured to connect the discharge head and the liquid container, a flow path valve configured to open and close the flow path, and an agitation unit configured to agitate the liquid in the liquid container, the method comprising:
discharging liquid from the discharge head; and
in a case where the agitation unit performs agitation during a recording operation, closing the flow path by using the flow path valve.
